(19) United States
(12) Patent Application Publication
(10) Pub. No.: US 2022/0358524 A1
(43) Pub. Date: Nov. 10, 2022

(54) METHODS AND SYSTEMS FOR MONITORING BRAND PERFORMANCE BASED ON CONSUMER BEHAVIOR METRIC DATA AND EXPENDITURE DATA RELATED TO A COMPETITIVE BRAND SET OVER TIME

(71) Applicant: Mass Minority Inc., Toronto (CA)

(72) Inventors: Brett William Mathew Channer, Clarksberg (Town of Blue Mountains) (CA); Esme Rottschafer, Kingston (CA); Jeremy Grant Chrystman, Toronto (CA); Wee Khang Teo, Scarborough (CA); John Liam Sproule Tengelis, Owen Sound (CA); Mark J. Fuller, Markham (CA); Adao Hentges, Toronto (CA)

(73) Assignee: Mass Minority Inc., Toronto (CA)

(21) Appl. No.: 17/863,320

(22) Filed: Jul. 12, 2022

Related U.S. Application Data
(63) Continuation of application No. 17/011,467, filed on Sep. 3, 2020.

(51) Int. Cl. G06Q 30/02; G06F 9/54; G06F 16/2457; G06F 16/9537

(52) U.S. Cl. CPC G06Q 30/0201; G06F 9/54; G06F 16/24578; G06F 16/9537

(57) ABSTRACT

Computer-implemented methods and systems are provided that monitor brand performance in a holistic manner summarize in a single score for a set of competitive brand names over time and in different geographical through different mass media and digital media channels (e.g., paid, earned, and owned media channels). In embodiments, the methods and systems take into account i) different influence factors that pertain to a brand's influence on consumer behavior in the different media channels over time and in different geographical territories as well as ii) the expenditures (spending) made by the brand owner or agent with respect to advertisements and marketing materials or promotional material that use the brand in the different media channels over time and/or in the different geographical territories. Other systems and methods for monitoring and evaluating brand performance are disclosed and claimed.

### CROSS-REFERENCE TO RELATED APPLICATION(S)

The present application is a continuation of U.S. application Ser. No. 17/011,467, filed on Sep. 3, 2020, herein incorporated by reference in its entirety.

### BACKGROUND

### 1. Field

The present application relates to methods and systems for generating and visualizing information related to brand performance in different media channels.

### 2. Related Art

Current methods and systems for monitoring brand performance, or a brand's market behavior, are typically data source centric. For example, conventional online marketing monitoring methods and systems focus on factors such as, number of ads bought, number of clicks per view, number of conversions, and the like, from a particular source provider over a multitude of data points.

The current methods and systems also fail to offer the brand owner the opportunity to factor in the brand owner's investment or overall expenditure to assist in determining the return on the brand owner's investment in a brand. Accordingly, the brand owner is required to monitor performance separately for each data source/service provider, and independently monitor the return on investment in a brand.

The current methods and systems also fail to offer the brand owner the opportunity to factor in what media channels are most relevant to invest in relation to the consumer unique behavior in a given brand category.

Furthermore, there is often volatile changes in consumer behavior with respect to a brand over time, particularly in online media channels, and there can be differences in the volatility of such consumer behavior in different media channels in relation to one another. The current methods and systems for monitoring brand performance do not take such volatility into account.

### SUMMARY

The present application provides computer-implemented methods and systems for monitoring brand performance in a holistic manner for a set of competitive brand names over time and in different geographical territories. The methods and systems can be configured to account for volatility in consumer behavior with respect to the set of competing brand names in different media channels (including online media channels) over time, and also take into account the volatility in each media channel relative to other media channels during that period of time. The methods and systems can take into account i) different influence factors that pertain to a brand's influence on consumer behavior in different media channels over time and in different geographical territories, and ii) the expenditures (spending) made by the brand owner or agent with respect to advertisements and marketing materials or promotional material that use the brand in the different media channels over time and/or in the different geographical territories. The methods and systems obtain influence-related source data from different data sources. The influence-related source data pertains to the different influence factors for a given brand name over time periods and in different geographical territories. The selection of the data sources themselves as well as the influence-related source data that is obtained from the data sources are based on the influence factors, which relate to different aspects as to how a brand influences consumer behavior or emotions in different media channels of the marketplace. The methods and systems also obtain exposure-related source data from different sources. The exposure-related source data pertains to expenditures (spending) made by the brand owner or agent with respect to advertisements or marketing materials or promotional materials that use the brand name in the different media channels over time periods and in different geographical territories from different data sources. The influence-related source data and the exposure-related source data for each brand name are stored and process by transformation into corresponding metric data of a predefined format for storage in a data store. This process is performed separately for each brand name in the set of competing brand names. The metric data resulting from the transformation process combines and consolidates influence-related metric data for the different media channels (and possibly different geographical territories) over time with exposure-related metric data (possibly for different geographical territories) over time. Such metric data is stored in the data store and accessed in real time in response to user interaction that specifies a campaign or brand category related to a particular brand name. A relevant time window and geographical territory (or collection of geographical territories) related to the campaign or particular brand name can also be associated with the campaign or specified by the user interaction. The set of competing brand names can also be associated with the campaign or particular brand name or specified by the user interaction. In response to the user interaction, for each brand name in the set of competing brand names, the data store is queried to extract from the data store influence-related metric data that corresponds to the brand name, relevant geographical territory and one or more time periods that cover the relevant time window, and the extracted influence-related metric data is used to calculate a number of influence factor scores for the brand name during that time period. The influence factor scores are used in conjunction with corresponding weights to calculate an influence score for the brand name and the relevant geographical territory and the relevant time window. The weights can be configured to specify the relative weight of the influence factor scores on the resultant influence score. For example, the weights can be configured to give some of the influence factor scores more, the same, or less “weight” or influence on the resultant influence score than other influence factor scores in the same set. Furthermore, the data store is queried to extract from the data store exposure-related metric data that corresponds to the brand name and the relevant geographical territory and one or more time periods that cover the relevant time window, and the extracted exposure-related metric data is used to calculate an exposure score for the brand name and the relevant geographical territory and the relevant time window. The influence score and the exposure score for the brand name are used to calculate a brand score for the brand name and the relevant geographical territory and the relevant time window. This scoring process is performed separately for each brand name in a set of competing brand names. The brand scores for the set of competing brand names can be presented in a display (e.g. display window) for visualization. For example, the brand scores for the set of competing brand names can be presented for display in a matrix form which includes a plurality of visual elements corresponding to the set of competing brand names plotted in a two-dimensional exposure-influence coordinate system. Each visual element can be displayed at a position corresponding to the exposure score and influence score for the corresponding brand name. The size (e.g., diameter) of each visual element can be based on the brand score of the corresponding brand name. Other visualizations (e.g., display windows) based on the scores or rankings and the underlying metric data can be also presented for display. As a result, a brand owner can make more informed decisions in assessing brand performance of a brand in relation to a set of competing brands over a geographical territory (or collection of territories) and a relevant time window.

Advantageously, the computer-implemented methods and systems allow brand owners or their agents to understand a brand's total influence and effectiveness in different media channels (including in digital media channels and mass media channels) in one or more geographical territories and in a time window in a single scoring and ranking. The scoring or ranking considers the expenditures related to the set of competing brand names as well as the volatility in consumer behavior with respect to the set of competing brand names in different media channels (including online media channels) over time. The scoring or ranking can be used by a brand owner or agent to make more informed decisions on advertising and/or marketing investments for a given brand over different geographical territories and different time windows.

For example, the computer-implemented methods and systems can be executed prior to an advertising campaign to understand the marketplace for the brand name and plan the advertising campaign, including which media channels to emphasize or use and how much expenditures (or relative expenditures) should be targeted for spending over the individual media channels as part of the advertising campaign.

In another example, the computer-implemented methods and systems can be executed during an advertising campaign to understand the volatility in the marketplace for the brand name during the advertising campaign and dynamically adjust and optimize the advertising campaign, including which media channels to emphasize or use and how much expenditures (or relative expenditures) should be targeted for spending over the individual media channels as part of the remainder (or other relevant time window) of the advertising campaign. In this manner, the real-time capability of the computer-implemented methods and systems can provide a test, learn, and adapt framework that allows for dynamic adjustment and optimization of an advertising campaign prior to major expenditures as part of the advertising campaign.

In still another example, the computer-implemented methods and systems can be executed after an advertising campaign to understand the performance and effectiveness of the advertising campaign in the marketplace for the brand name. Such information can be used to plan follow-on one or more advertising campaigns for the brand name or the advertising campaign(s) for related brand names.

In embodiments, the influence-related source data that pertains to the different influence factors for a given brand name can be obtained in an automatic manner from different data sources that are accessed via corresponding online application programming interfaces (APIs). For example, a data processing system or platform (e.g., data collection server) can be configured to access a particular data source via a predefined online API for that data source, where the online API involves data communication over the Internet to automatically obtain influence-related source data stored by the data source that pertains to a given brand name and corresponding influence factor. The operations of the data processing system or platform that use the online API can be initiated in an automatic programmed manner by automated detection of one or more trigger events or conditions. The trigger events or conditions can include one or more time-based scheduled events. Alternatively, or additionally, the trigger events or conditions can involve predefined user-input operations. Parameters of the online API for a particular data source as well as parameters for the trigger events or conditions can be stored in a control table or other data structure and accessed by the data processing system or platform to generate a script that carries out the operations of the data processing system or platform using the online API to automatically obtain the influence-related source data that pertains to a corresponding influence factor and brand name from the appropriate data source through data communication over the Internet. The obtained influence-related source data can be stored with time-stamp data for subsequent processing. The time stamp data can represent a time period corresponding to the influence-related source data associated therewith. The time-stamp data, for example, can represent a start date and end date. The time period represented by the time-stamp data can represent a day, month, year, or other period of time. Such operations can be performed to obtain and store influence-related source data that pertains to different geographical territories (such as countries, regions, states, etc.) for a given time period. Such operations can also be repeatably performed over time to obtain and store influence-related source data that pertains to different geographical territories and/or different time periods for a given brand name. Furthermore, such operations can be performed separately for each brand name in the set of competing brand names.

In embodiments, the exposure-related source data for a given brand name can be obtained in an automatic manner from one or more data sources that are accessed via corresponding online APIs. For example, a data processing system or platform (e.g., data collection server) can be configured to access a particular data source via a predefined online API for that data source, where the online API involves data communication over the Internet to automatically extract and obtain exposure-related source data stored by the data source that pertains to a given brand name. The operations of the data processing system or platform that use the online API can be initiated in an automatic programmed manner by automated detection of one or more trigger events or conditions. The trigger events or conditions can include one or more time-based scheduled events. Alternatively or additionally, the trigger events or conditions can involve predefined user-input operations. Parameters of the online API for a particular data source as well as parameters for the trigger events or conditions can be stored in a control table or other data structure and accessed by the data processing system or platform to generate a script that carries out the operations of the data processing system or platform using the online API to automatically obtain the exposure-related source data that pertains to a brand name from the appropriate data source through data communication over the Internet. The obtained exposure-related source data can be stored with time-stamp data. The time stamp data can represent a time period corresponding to the exposure-related source data associated therewith. The time-stamp data, for example, can represent a start date and end date. The time period represented by the time-stamp data can represent a day, month, year, or other period of time. Such operations can be performed to obtain and store exposure-related source data that pertains to different geographical territories (such as countries, regions, states, etc.) for a given time period. Such operations can be repeatably performed over time to obtain and store exposure-related source data that pertains to different geographical territories and/or different time periods for a given brand name. Furthermore, such operations can be performed separately for each brand name in the set of competing brand names.

In embodiments, data representing the brand names in the set of competing brand names can be associated with a campaign or brand category, which can be referred to as an event. Such brand data as well as related parameters that are used in the online APIs to access the appropriate data sources can be stored in a control table or other suitable data structure and accessed to generate the scripts that carry out the operations of the data processing system or platform using the online APIs for the respective brand names in the set of competing brand names.

In embodiments, a data processing system can be configured to process and transform the influence-related source data and the exposure-related source data that pertain to a given brand name and given time period and given geographical territory into corresponding metric data of a predefined format, and load the resulting metric data into a data store whereby the metric data is associated with (or indexed by) the given brand name and given time period and given geographical territory. The time period can represent a day, month, year, or other period of time. The geographical territory can represent a country (such as the United States or Canada), a collection of countries, (such as Europe or Latin America), a region within a country, a collection of regions within a country, a state within a country, a collection of states within a country, or other geographical region or territory. This process can be performed for multiple geographical territories and multiple time periods for a given brand such that the process transforms the influence-related source data and the exposure-related source data pertaining to the given brand and the respective geographical territories and/or respective time periods, and the resulting metric data stored in the data store is associated with (or indexed by) the given brand name and different geographical territories and different time periods. Furthermore, this process can be performed separately for each brand name in a set of competing brand names such that the resulting metric data stored in the data store is associated with (or indexed by) the respective brand names and different geographical territories and different time periods.

In embodiments, a portal application server or processing platform can be configured to authentic authorized users via data communication over the Internet and permit an authorized user to provide user interactions via data communication over the Internet wherein such user interactions specify a campaign or brand category related to particular brand. A relevant time window and geographical territory (or collection of geographical territories) can be related to the campaign or possibly specified by the user interaction. The time window can represent a day, month, year, or other period of time. The relevant geographical territory can represent a country (such as the United States or Canada), a collection of countries, (such as Europe or Latin America), a region within a country, a collection of regions within a country, a state within a country, a collection of states within a country, or other geographical region or territory. A set of competing brand names can also be associated with the campaign or particular brand name or specified by the user interaction. For each brand name in the set of competing brand names, the data store is queried to extract influence-related metric data that corresponds to the brand name and relevant geographical territory and one or more time periods that cover the relevant time window from the data store, and the extracted influence-related metric data is used to calculate a number of influence factor scores for the brand name. The influence factor scores are used in conjunction with corresponding weights to calculate an influence score for the brand name and the relevant geographical territory and the relevant time window. The weights can be configured to specify the relative weight of the influence factor scores on the resultant influence score. For example, the weights can be configured to give some of the influence factor scores more, the same, or less “weight” or influence on the resultant influence score than other influence factor scores in the same set. Furthermore, the data store is queried to extract exposure-related metric data that corresponds to the brand name and the relevant geographical territory and one or more time periods that cover the relevant time window from the data store, and the extracted exposure-related metric data is used to calculate an exposure score for the brand name and the relevant geographical territory and the relevant time window. The influence score and the exposure score for the brand name are used to calculate a brand score for the brand name and the relevant geographical territory and the relevant time window. This process is performed for each brand name in the set of competing brand names. The brand scores for the set of competing brand names can be presented in a display (e.g. display window) for visualization. Other visualizations based on the brand scores or rankings and the underlying metric data can be also presented for display.

In embodiments, the weights used to calculate the brand score for a given brand name correspond to the different influence factors. The weights can vary for different categories of brand names. In this case, the weights can depend on the category of the brand name.

In embodiments, the relevant time window can cover multiple time periods. In this case, the influence factor scores for the given brand name and the relevant geographical territory and the relevant time window can be based on averaging or combining extracted influence-related metric data that corresponds to the multiple time periods. Alternatively, the influence score for the given brand name and the relevant geographical territory and the relevant time window can be based on averaging or combining influence scores that correspond to the multiple time periods. Furthermore, the exposure score for the given brand name and the relevant geographical territory and the relevant time window can be based on averaging or combining extracted exposure-related metric data that corresponds to the multiple time periods. Alternatively, the exposure score for the given brand name and the relevant geographical territory and the relevant time window can be based or based on averaging or combining exposure scores that correspond to the multiple time periods. And furthermore, the brand score for the given brand name and the relevant geographical territory and the relevant time window can be based on the influence score that covers the multiple time periods and the exposure score that covers the multiple time periods. Alternatively, the brand score for the given brand name and the relevant geographical territory and the relevant time window can be based on averaging or combining brand scores that correspond to the multiple time periods.

In embodiments, the methods and systems can derive the brand score for a particular brand name based on expenditures for the given brand name and the relevant geographical territory and the relevant time window. The expenditures can be adjusted based on an effectiveness factor for the particular brand name determined for market share of the particular brand name over time. The market share of the particular brand name is a measure of consumer preference for one or more products that are branded by the particular brand name over other similar or competing products. The effectiveness factor for the particular brand name can be configured to adjust monetary expenditures for the particular brand name in a manner that rewards monetary expenditures that contribute to the market share gain of the particular brand name over time and penalizes monetary expenditures that contribute to market share loss of the particular brand name over time.

In embodiments, the methods and systems can present for display brand scores and/or influence factor scores for a particular brand name for different points in time within a time window.

Further scope of applicability of the invention will become apparent from the detailed description given hereinafter. However, it should be understood that the detailed description and specific examples, while indicating exemplary embodiments of the invention, are given by way of illustration only, since various changes and modifications within the spirit and scope of the invention will become readily apparent to those skilled in the art.

### BRIEF DESCRIPTION OF THE DRAWINGS

FIG. 1 is a high-level functional block diagram of a system for monitoring brand performance according to the present disclosure.

FIG. 2 is a flow chart illustrating automated data collection and data transformation operations carried out by the system of FIG. 1 according to an illustrative embodiment of the present disclosure; the data collection and data transformation operations automatically obtain influence-related source data and exposure-related source data from different online databases and store such data in the source database of FIG. 1. The obtained source data as stored in the source database is transformed to corresponding metric data of a predefined format that is stored in the primary database of FIG. 1.

FIGS. 3A and 3B, collectively, is a flow chart illustrating a portal application process carried out by the system of FIG. 1 according to an illustrative embodiment of the present disclosure; the portal application process interacts with users in real-time to dynamically build and display a brand attraction matrix based on the influence-related metric data and the exposure-related metric data stored in the primary database of FIG. 1.

FIGS. 4A and 4B, collectively, is a flow chart illustrating exemplary automated data collection operations that can be carried out as part of the process of FIG. 2.

FIG. 5 is a flow chart illustrating exemplary data transformation operations that can be carried out as part of the process of FIG. 2.

FIGS. 6A, 6B and 6C, collectively, is a flow chart illustrating exemplary operations that calculate a brand score based on the influence-related metric data and the exposure-related metric data stored in the primary database as part of the process of FIGS. 3A and 3B.

FIGS. 7A and 7B, collectively, is a flow chart illustrating exemplary operations that calculate a set of weights corresponding to different influence factors for use in the brand scoring calculations of FIGS. 6A, 6B and 6C.

FIG. 8 is a schematic illustration of different online databases and manual entry means that can be accessed or used to obtain influence-related source data and exposure-related source data as well as other data that is stored in the source database for processing by the system.

FIG. 9 is a schematic illustration of exemplary database tables that store data representing parameters for competing brand names as well as associated clients and campaigns and other data.

FIG. 10 is a schematic illustration of exemplary database tables that store influence-related metric data and exposure-related metric data as part of the primary database of FIG. 1.

FIG. 11 illustrates an exemplary graphical user interface (e.g., display window) that displays a brand attraction matrix (BAM) produced by the process of FIGS. 3A and 3B.

FIG. 12 illustrates an exemplary graphical user interface (e.g., display window) for user authentication as part of the process of FIGS. 3A and 3B.

FIG. 13 illustrates an exemplary graphical user interface (e.g., display window) for user input in specifying a campaign or related query as part of the process of FIGS. 3A and 3B.

FIG. 14 illustrates an exemplary graphical user interface (e.g., display window) that displays a table based on the results of the process of FIGS. 3A and 3B; the rows of the table correspond to differ brand names, the columns of the table correspond to exposure score, adjusted exposure score, the set of influence factor scores, and the brand score for the different brand names, and the table entries (for each column and row) employ a color scheme that represents the different values of the corresponding scores.

FIG. 15 illustrates an exemplary graphical user interface (e.g., display window) that displays the brand score for a particular brand name along with its ranking in the set of competing brands and the set of influence factor scores for the brand name as produced by the process of FIGS. 3A and 3B.

FIG. 16 illustrates an exemplary graphical user interface (e.g., display window) that displays influence indicators as well as attraction indicators for different brand names in the set of competing brand names; the influence indicators (“X”, “−”, or “✓”) are based on the set of influence factor scores for the respective brand name as produced by the process of FIGS. 3A and 3B; the attraction indicators (“X”, “−”, or “✓”) are based on the brand scores for the respective brand name as produced by the process of FIGS. 3A and 3B.

FIGS. 17 to 23 illustrate exemplary graphical user interfaces (e.g., display windows) that display influence factors scores or exposure scores for different brand names as produced by the process of FIGS. 3A and 3B.

FIG. 24 is a visual depiction of social mentions that are communicated over social media and pertain to advertising material that employs a particular brand name.

FIG. 25 illustrates an exemplary graphical user interface (e.g., display window) that displays plots of brand scores and related influence factor scores for a particular brand name for different points in time within a time window; these scores are produced for a given point in time within the time window by the process of FIGS. 3A and 3B.

FIG. 26 illustrates an exemplary graphical user interface (e.g., display window) that displays plots of influence factor scores for a particular brand name for different points in time within a time window; these influence factor scores are produced for a given point in time within the time window by the process of FIGS. 3A and 3B, and shading is used to display the bounds between the maximum and minimum for each influence factor score over the time window.

FIG. 27 illustrates another exemplary graphical user interface (e.g., display window) that displays plots of influence factor scores for a particular brand name for different points in time within a time window; similar to FIG. 26, these influence factor scores are produced for a given point in time within the time window by the process of FIGS. 3A and 3B, and shading is used to display the bounds between the maximum and minimum for each influence factor score over the time window.

FIG. 28 illustrates a functional block diagram of an exemplary computer processing system that can be used to implement one or more of the processes of the present disclosure, such as some or all of the processes performed by the data collection server, the source database, the data processing system, the primary database, and the portal application system of FIG. 1.

FIG. 29 is a flow chart illustrating a portal application process carried out by the system of FIG. 1 according to an illustrative embodiment of the present disclosure; the portal application process interacts with users in real-time to perform on-demand or ad-hoc querying of the influence-related metric data and the exposure-related metric data stored in the primary database of FIG. 1 to evaluate brand performance.

### DETAILED DESCRIPTION OF THE PREFERRED EMBODIMENTS

The term “source data” as used herein refers to data that is obtained or collected from one or more data sources for processing; the data source(s) can include one or more public online databases, one or more private online databases (which typically require a subscription or other commercial arrangement with the database provider for access), other web services, one or more offline databases, manual data input (such as importation of spreadsheet data or other formatted data), and possibly other data sources.

The term “metric data” as used herein refers to data that is derived by processing or transforming source data.

The term “influence” or “influence-related” as used herein refers to a certain type of source data, metric data and scores based thereon which relate to, characterize or reflect the influence of a brand on consumer behavior or emotions in the marketplace (which can include online digital media channels, mass media channels, social media channels and public relations (PR) channels) where consumers or other market participants interact with advertising, marketing or promotional material of a brand).

The term “exposure” or “exposure-related” as used herein refers to a certain type of source data, metric data and scores based thereon which relate to, characterize or reflect expenditures or spending by a brand owner or agent with respect to advertisements or marketing material or promotional material that use a brand name.

The computer-implemented methods and systems as described herein allow brand owners or their agents to understand a brand's total influence in different media channels (such as online digital media channels, mass media channels, social media channels, general consumer sentiment, and public relations (PR) channels) in one or more geographical territories and in a time window in a single scoring and ranking so that the brand owner or agent can make more informed decisions on advertising and/or marketing investments for a given brand in different geographical territories and/or over different time windows.

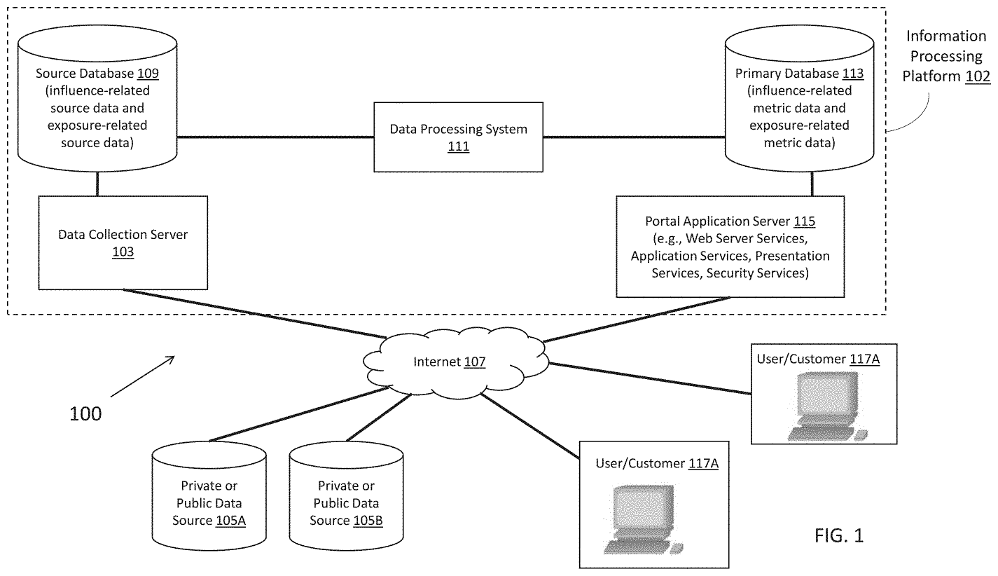

Turning now to FIG. 1, there is shown the system architecture of a distributed electronic system 100 according to the present disclosure. The system 100 includes a service 102 (which is referred to in the drawings as “Information Processing Platform”) having a data collection server 103, a source database 109, a data processing system 111, a primary database 113, and a portal application server 115. The data collection server 103 is a computer system that executes software that is configured to collect or obtain influence-related source data that pertains to different influence factors for a given brand name over time periods and in different geographical territories from a number of data sources (for example, two shown as 105A, 105B). The data source(s) for the influence-related source data can include one or more public online databases, one or more private online databases (which typically require a subscription or other commercial arrangement with the database provider for access), other web services, one or more offline databases, manual data input (such as importation of spreadsheet data or other formatted data), and possibly other data sources. The selection of the data sources themselves as well as the influence-related source data that is obtained from the data sources are based on a set of influence factors, which relate to different aspects as to how a brand influences consumer behavior or emotions in different media channels of the marketplace. The data collection server 103 is also configured to collect or obtain exposure-related source data that pertains to the given brand name in the different media channels over time periods and in different geographical territories from different data sources. The data source(s) for the exposure-related source data can include one or more public online databases, one or more private online databases (which typically require a subscription or other commercial arrangement with the database provider for access), other web services, one or more offline databases, manual data input (such as importation of spreadsheet data or other formatted data), and possibly other data sources. The time periods associated with the influence-related source data and the exposure-related source data can represent a day, month, year, or other period of time. The geographical territories associated with the influence-related source data and the exposure-related source data can represent countries, regions, states, other territory, etc. The influence-related source data and the exposure-related source data obtained by the data collection server 102 for each brand name are stored in the source database 109. The source database 109 can be realized by a relational database, multi-dimensional database, or other data store. The data processing system 111 is a computer system that executes software that is configured to process the influence-related source data and the exposure-related source data stored in the source database 109 for transformation into corresponding influence-related metric data and exposure-related metric of predefined format for storage in the primary database 113. The primary database 113 can be realized by a relational database, multi-dimensional database, data warehouse or other data store. These processes can be performed by the data collection server 103 and the data processing system 111 separately for each brand name in a set of competing brand names. The processes performed by the data collection server 103 and the data processing system 111 can be coordinated by automatic means, such as messaging or other data communication, by manual intervention, or by semi-automatic means.

The portal application server 115 is a networked computer system that executes software that is configured to interact with user/customers operating user/customer systems 117A via data communication over Internet 107. The portal application server 115 is further configured to access the metric data stored in the primary database 113 in real time in response to such user interaction that specifies a campaign or brand category related to a particular brand name as well as a relevant time window and geographical territory (or collection of geographical territories). The relevant time window can represent a day, month, year, or other period of time. The relevant geographical territory (or collection of geographical territories) can represent a country, region, state, other territory, or collections thereof. Specifically, in response to the user interaction, for each brand name in the set of competing brand names corresponding to the campaign or brand category, the primary database 113 is queried to extract influence-related metric data that corresponds to the brand name and to the relevant time window and the geographical territory from the primary database 113, and the extracted influence-related metric data is used to calculate a number of influence factor scores for the brand name. The influence factor scores are used in conjunction with corresponding weights to calculate an influence score for the brand name. The weights can be configured to specify the relative weight of the influence factor scores on the resultant influence score. For example, the weights can be configured to give some of the influence factor scores more, the same, or less “weight” or influence on the resultant influence score than other influence factor scores in the same set. Furthermore, the primary database 113 is queried to extract exposure-related metric data that corresponds to the brand name and to the relevant time window and the geographical territory from the primary database 113, and the extracted exposure-related metric data is used to calculate an exposure score for the brand name. The influence score and the exposure score for the brand name are used to calculate a brand score for the brand name and the relevant time window and the geographical territory. The portal application server 115 performs this scoring process separately for each brand name in a set of competing brand names.

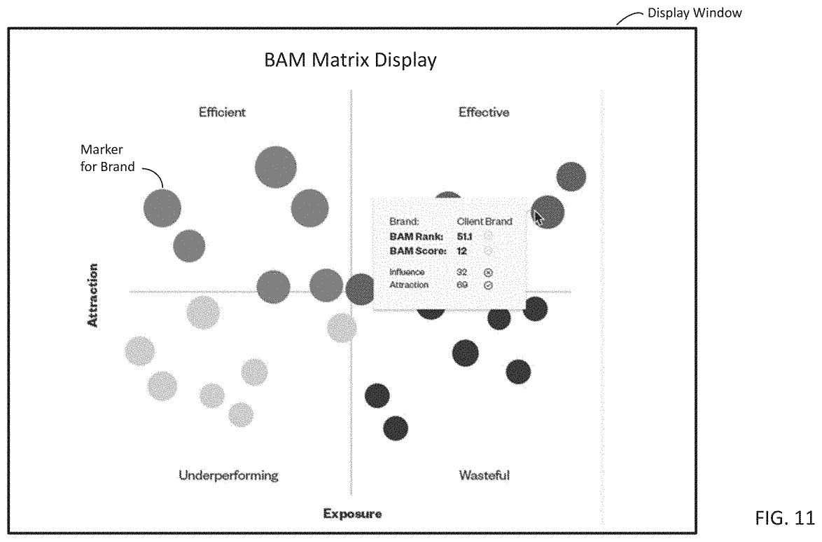

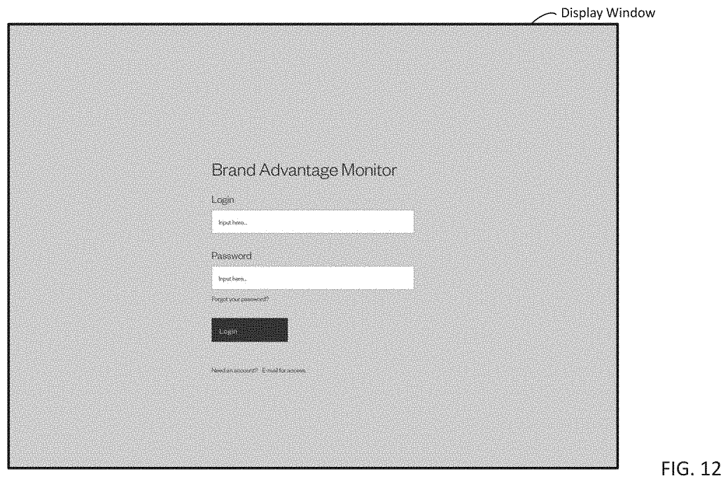

Furthermore, the portal application server 115 is configured to present the brand scores for the set of competing brand names in a display (e.g. display window of a user/customer terminal 117A) for visualization. For example, the brand scores for the set of competing brand names can be presented for display in a matrix form which includes a plurality of visual elements corresponding to the set of competing brand names plotted in a two-dimensional exposure-influence coordinate system (e.g., FIG. 11). Each visual element can be displayed at a position corresponding to the exposure score and influence score for the corresponding brand name. The size (e.g., diameter) of each visual element can be based on the brand score of the corresponding brand name. Other visualizations (e.g., display windows) based on the scores or rankings and the underlying metric data can be also presented for display (e.g., FIGS. 12 to 21).

As a result, the user (e.g., brand owner or agent) can advantageously make more informed decisions in assessing brand performance of a brand in relation to a set of competing brands over a relevant time window and geographical territory (or collection of territories) from a single measure of comparison versus a series of unrelated measures.

For example, the computer-implemented methods of the electronic system 100 can be executed prior to an advertising campaign to understand the marketplace for the brand name and plan the advertising campaign, including which media channels to emphasize or use and how much expenditures (or relative expenditures) should be targeted for spending over the individual media channels as part of the advertising campaign.

In another example, the computer-implemented methods of the electronic system 100 can be executed during an advertising campaign to understand the volatility in the marketplace for the brand name during the advertising campaign and dynamically adjust and optimize the advertising campaign, including which media channels to emphasize or use and how much expenditures (or relative expenditures) should be targeted for spending over the individual media channels as part of the remainder (or other relevant time window) of the advertising campaign. In this manner, the real-time capability of the computer-implemented methods and systems can provide a test, learn, and adapt framework that allows for dynamic adjustment and optimization of an advertising campaign prior to major expenditures as part of the advertising campaign.

In still another example, the computer-implemented methods of the electronic system 100 can be executed after an advertising campaign to understand the performance and effectiveness of the advertising campaign in the marketplace for the brand name. Such information can be used to plan follow-on one or more advertising campaigns for the brand name or the advertising campaign(s) for related brand names.

The software resources of the portal application server 115 can also include web server services, application services, presentation services and security services. The presentation services are facilities that enable delivering dynamic content to the user/customer systems 117A. Preferably, the presentation services support Active Server Pages, JavaServer pages, server-side scripting such as PHP, Ruby, Perl, CGI, PL/SQL scripting, etc.

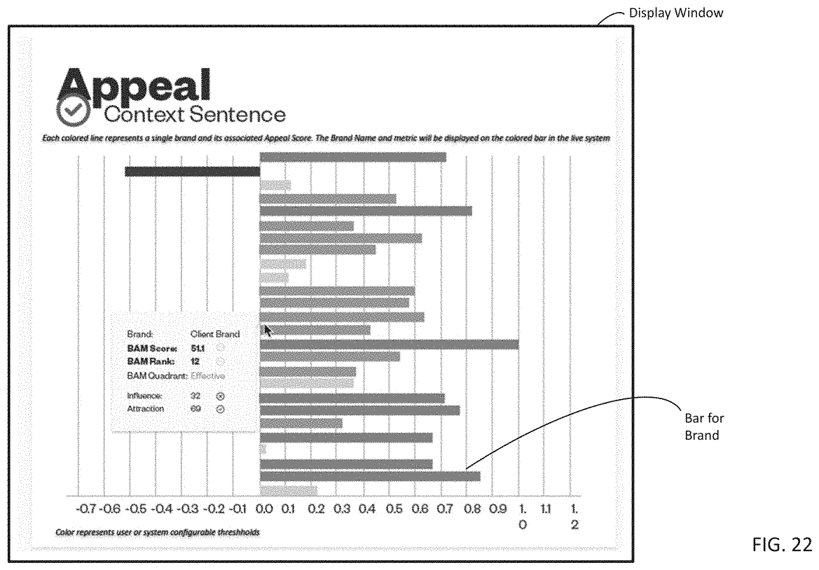

The data processing functionality of data collection server 103, source database 109, data processing system 111, primary database 113, and the portal application server 115 can be realized on one or more data processing platforms (for example, see FIG. 22). The data processing platforms can be implemented as separate data processing platforms, multiple virtual machines executing on a single data processing platform, and/or combinations thereof. Inter-process communication mechanisms (such as sockets, pipes, shared memory, message queues and message passing) can be used for communication between the platforms,

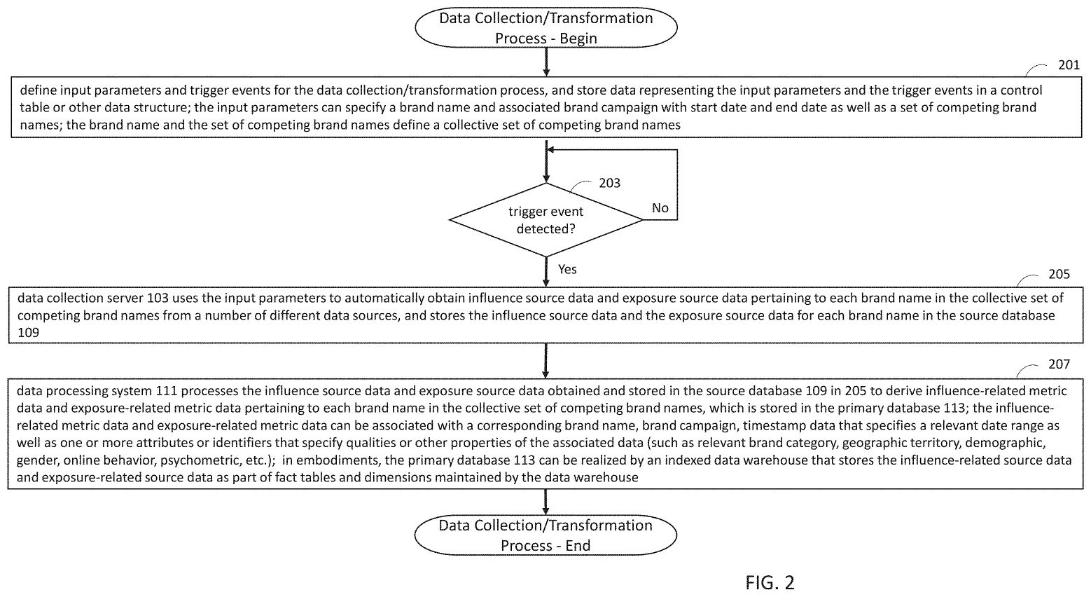

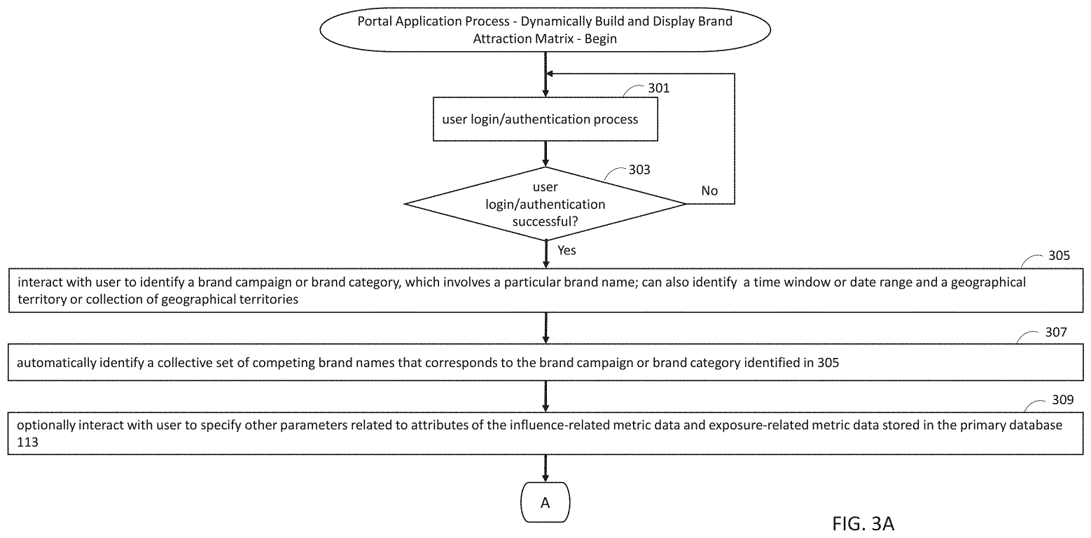

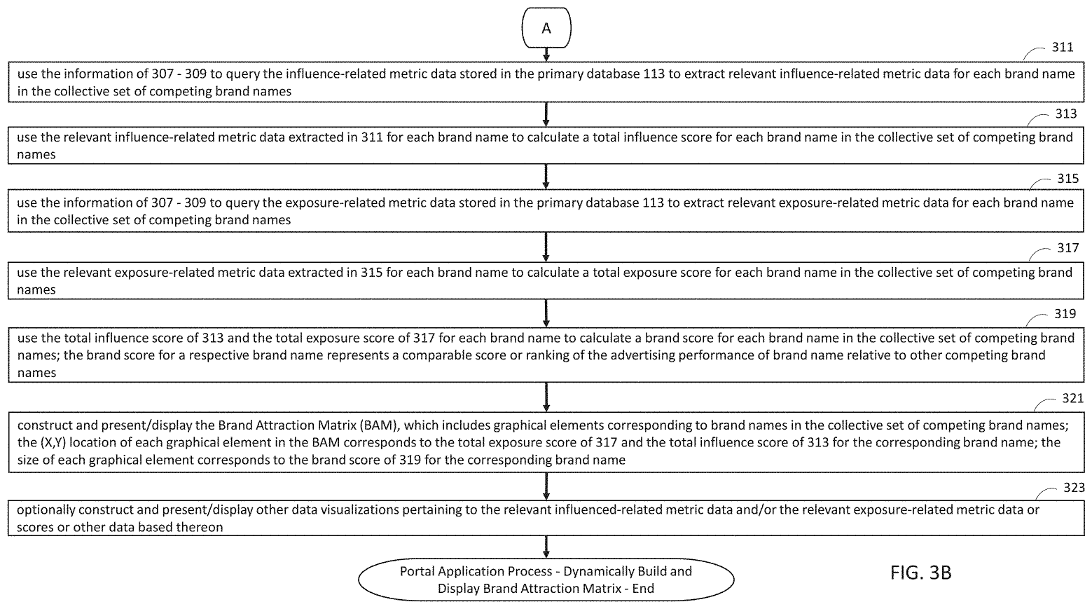

In one embodiment, the operations of the system 100 of FIG. 1 can be logically organized as a workflow of two process or phases including a data collection/transformation process and a portal application process. The collection/transformation process is illustrated in the flowchart of FIG. 2. The portal application process is illustrated in the flowchart of FIGS. 3A and 3B and is carried out by the portal application server 115 of FIG. 1.

Turning to FIG. 2, the data collection/transformation process begins in block 201 where input parameters and trigger events are defined for the data collection/transformation process, and data representing the input parameters and the trigger events are stored in in a control table or other data structure. The input parameters can specify a brand name and associated brand campaign with start date and end date as well as a set of competing brand names. The brand name and the set of competing brand names define a collective set of competing brand names. The input parameters can also specify one or more domain names associated with each given brand name. The control table or other data structure can be stored as part of data storage or memory of one or more components of the platform 102.

In block 203, the process checks whether a trigger event has been detected or activated. If so, the operations continue to block 205 and 207. The trigger events can include one or more time-based scheduled events. Alternatively or additionally, the trigger events can involve predefined user-input operations. In embodiments, the triggering event can involve predefined manual user-input operations that are performed by the user based on availability of source data and/or time windows best suited for the needs of the client or brand owner.

In block 205, the data collection server 103 is configured to use the input parameters stored in the control table or other data structure in block 201 to automatically obtain influence source data and exposure source data pertaining to each brand name in the collective set of competing brand names from a number of different data sources (e.g., 105A, 105B), and stores the influence source data and the exposure source data for each brand name in the source database 109 for processing in block 207.

In block 207, the data processing system 111 is configured to access the influence source data and exposure source data obtained and stored in 205 to derive influence-related metric data and exposure-related metric data pertaining to each brand name in the collective set of competing brand names, which is stored in the primary database 113. The influence-related metric data and exposure-related metric data stored in the primary database 113 can be associated with a corresponding brand name, brand campaign, timestamp data that specifies a date range as well as one or more attributes or identifiers that specify qualities or other properties of the associated data (such as geographic territory, category, demographic, gender, online behavior, psychometric, etc.). The, timestamp data associated with the influence-related source data and the exposure-related source data can represent a day, month, year, or other period of time. The geographical territories associated with the influence-related source data and the exposure-related source data can represent countries, regions, states, or collections thereof. In embodiments, the primary database 113 can be realized by an indexed data warehouse that stores the influence-related source data and exposure-related source data as part of fact tables and dimensions maintained by the data warehouse.

Turning to FIGS. 3A and 3B, the portal application process begins in block 301 by invoking a user login/authentication process. The user login/authentication process can require the user to enter a username and password that matches corresponding information stored for the user. Biometric matching data (such as thumbprint or facial image matching) or other suitable methods can also be used as part of the user login/authentication process.

In block 303, the process checks whether the user login/authentication process of block 301 was successful. If so, the operations continue to block 305 to 323.

In block 305, the process interacts with the authenticated user to identify a brand campaign or brand category which involves a particular brand name. The user interaction can also identify or specify a relevant time window or date range as well as geographical territory or collection of geographical territories. The relevant time window can represent a day, month, year, or other period of time. The relevant geographical territory (or collection of geographical territories) can represent a country, region, state, other territory, or collections thereof.

In block 307, the process automatically identifies a collective set of competing brand names that corresponds to the brand campaign or brand category identified in block 305. The collective set of competing brand names corresponding to the brand campaign or brand category can be identified by accessing data stored in the control table or other data structure as part of the input parameters of block 201.

In block 309, the process optionally interacts with the authenticated user to specify other parameters related to attributes or identifiers of the influence-related metric data and exposure-related metric data stored in the primary database for an arbitrary specified time period 113.

In block 311, the process uses the information of blocks 307 and 309 to query the influence-related metric data stored in the primary database 113 to extract relevant influence-related metric data for each brand name in the collective set of competing brand names. The relevant influence-related metric data that is extracted from the primary database 113 for a given brand name is associated with the given brand name and matches the time window or date range as well as geographical territory or collection of geographical territories of block 307 and possibly the optional parameters or attributes of block 309.

In block 313, the process uses the relevant influence-related metric data extracted in 311 for each brand name to calculate a total influence score for each brand name in the collective set of competing brand names.

In block 315, the process uses the information of blocks 307 and 309 to query the exposure-related metric data stored in the primary database 113 to extract relevant exposure-related metric data for each brand name in the collective set of competing brand names. The relevant exposure-related metric data that is extracted from the primary database 113 for a given brand name is associated with the given brand name and matches the time window or date range as well as geographical territory or collection of geographical territories of block 307 and possibly the optional parameters or attributes of block 309.

In block 317, the process uses the relevant exposure-related metric data extracted in 315 for each brand name to calculate a total exposure score for each brand name in the collective set of competing brand names.

In block 319, the process uses the total influence score of 313 and the total exposure score of 317 for each brand name to calculate an attraction score for each brand name in the collective set of competing brand names. The brand score for a respective brand name represents a comparable score or ranking of the advertising performance of brand name relative to other competing brand names.

In block 321, the process constructs and presents for display the Brand Attraction Matrix (BAM), which includes graphical elements (e.g., circular elements) corresponding to brand names in the collective set of competing brand names plotted in a two-dimensional exposure-influence coordinate system (e.g., FIG. 11). The (X,Y) location of each graphical element in the BAM corresponds to the total exposure score of 317 and the total influence score of 313 for the corresponding brand name. The size of each graphical element corresponds to the brand score of 319 for the corresponding brand name.

In block 323, the process optionally constructs and presents for display other data visualizations pertaining to the relevant influenced-related metric data and/or the relevant exposure-related metric data or scores or other data based thereon (e.g., FIGS. 12 to 21).

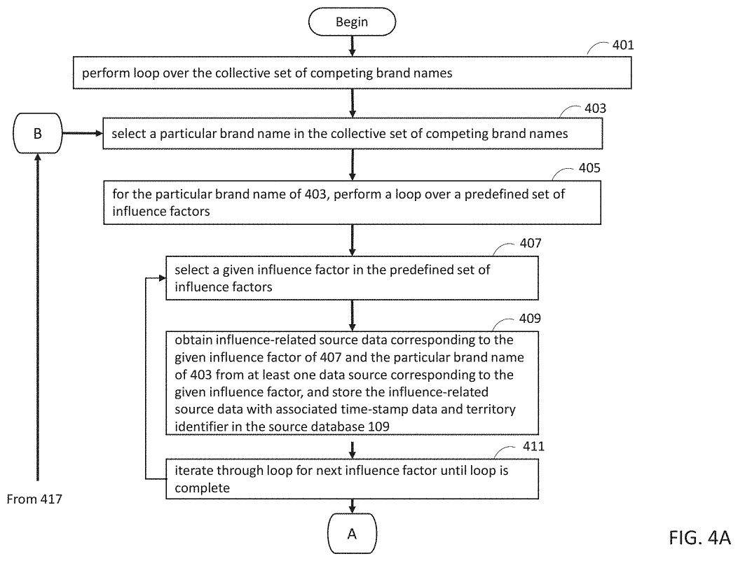

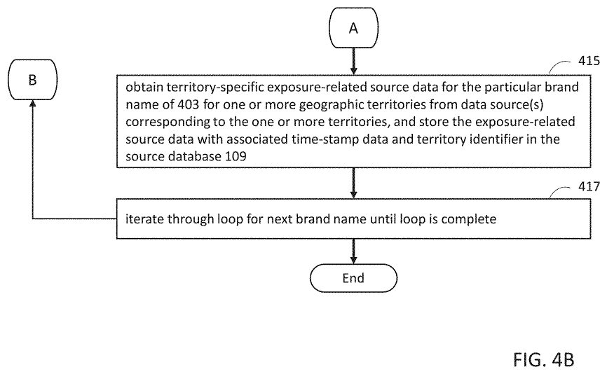

FIGS. 4A and 4B illustrate exemplary automated data collection operations that can be carried out as part of block 205 of the data collection/transformation process of FIG. 2. The operations begin in block 401 to perform a loop (blocks 403 to 417) over the collective set of competing brand names.

In block 403, the operations select a particular brand name in the collective set of competing brand names.

In block 405, the operations perform a loop (blocks 407 to 411) over a predefined set of influence factors for the particular brand name of 403.

In block 407, the operations select a given influence factor in the predefined set of influence factors.

In block 409, the operations obtain influence-related source data corresponding to the given influence factor of 407 and the particular brand name of 403 from at least one data source corresponding to the given influence factor, and store the influence-related source data with associated time-stamp data and territory identifier in the source database 109. The time stamp data can represent a time period corresponding to the influence-related source data associated therewith. The time-stamp data, for example, can represent a start date and end date. The time period represented by the time-stamp data can represent a day, month, year, or other period of time. The territory identifier can identify a particular geographical territory (such as a country, region, state, or other geographical territory). The operations of block 409 can be performed to obtain and store influence-related source data that pertains to different geographical territories (such as countries, regions, states, etc.) for a given time period and given brand name.

In block 411, the operations iterate through the loop of blocks 407 to 411 for the next influence factor until the loop is complete.

In block 413, the operations obtain territory-specific exposure-related source data for the particular brand name of 403 for one or more geographic territories from data source(s) corresponding to the one or more territories, and store the exposure-related source data with associated time-stamp data and territory identifier in the source database 109. The time stamp data can represent a time period corresponding to the exposure-related source data associated therewith. The time-stamp data, for example, can represent a start date and end date. The time period represented by the time-stamp data can represent a day, month, year, or other period of time. The territory identifier can identify a particular geographical territory (such as a country, region, state, or other geographical territory). The operations of block 413 can be performed to obtain and store exposure-related source data that pertains to different geographical territories (such as countries, regions, states, etc.) for a given time period and given brand name.

In block 417, the operations iterate through the loop of blocks 403 to 417 for the next brand name until the loop is complete.

Note that the operations of FIGS. 4A and 4B can be repeatably performed over time to obtain and store influence-related source data and exposure-related source data that is associated with different time periods in the source database 109.

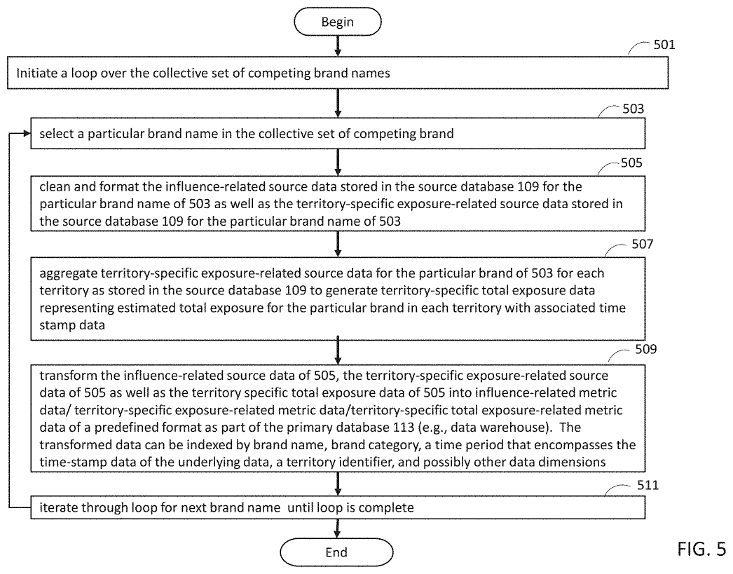

FIG. 5 illustrates exemplary data transformation operations that can be carried out as part of block 207 of the data collection/transformation process of FIG. 2. The operations begin in block 501 to perform a loop (blocks 503 to 511) over the collective set of competing brand names.

In block 503, the operations select a particular brand name in the collective set of competing brand names.

In block 505, the operations clean (removing data that contains errors) and format the influence-related source data stored in the source database 109 for the particular brand name of 503 as well as the territory-specific exposure-related source data stored in the source database 109 for the particular brand name of 503.

In block 507, the operations aggregate territory-specific exposure-related source data for the particular brand of 503 for each geographical territory as stored in the source database 109 to generate territory-specific total exposure data representing estimated total exposure for the particular brand in each one of the geographical territories with associated time stamp data. The aggregation of the exposure-related source data can occur over different media channels (such as online digital media channels, mass media channels, social media channels, and PR media channels) such that territory-specific total exposure data represents estimated total exposure over these different media channels for the particular brand in each one of the geographical territories with associated time stamp data.

In other embodiments, the territory-specific exposure-related source data for the particular brand of 503 can be aggregated over dimensions other than media channels. Such dimensions can be configured or selected to the area of inquiry. For example, if suitable exposure-related source data is available, the aggregation of the exposure-related source data can occur over countries, state/province, city, or even lower levels of granularity. In practice there are limits on the availability of fine grain geographic data so mostly territory refers to country or state/province.

In block 509, the operations transform the influence-related source data of 505, the territory-specific exposure-related source data of 505 as well as the territory specific total exposure data of 505 into influence-related metric data/territory-specific exposure-related metric data/territory-specific total exposure-related metric data of a predefined format as part of the primary database 113 (e.g., data warehouse). The transformed data can be indexed by brand name, brand category, a time period that encompasses the time-stamp data of the underlying data, a territory identifier that identifies the geographical territory of the underlying data, and possibly other data dimensions.

In block 511, the operations iterate through the loop of blocks 503 to 511 for the next brand name until the loop is complete.

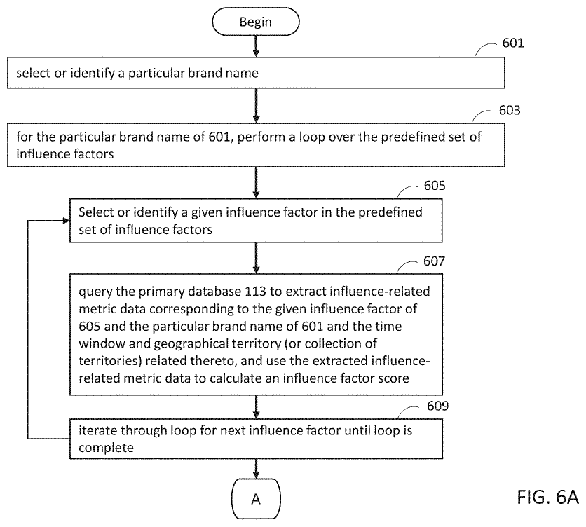

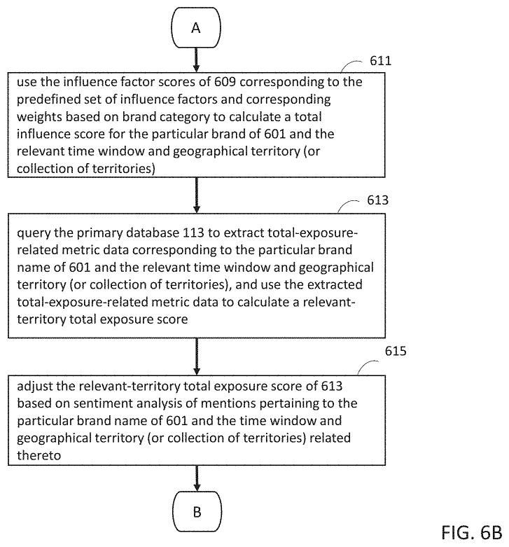

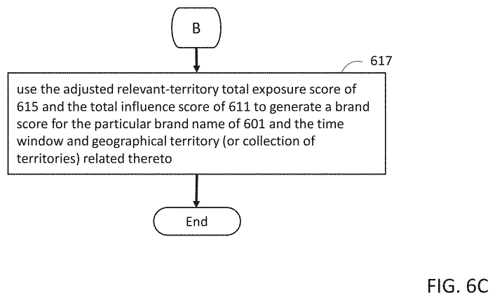

FIGS. 6A, 6B and 6C illustrate exemplary operations that calculate a brand score based on the influence-related metric data and the exposure-related metric data stored in the primary database as part of the process of FIGS. 3A and 3B. The operations begin in block 601 where the operations select or identify a particular brand name.

In block 603, the operations perform a loop (blocks 605-609) over the predefined set of influence factors for the particular brand name of 601.

In block 605, the operations select or identify a given influence factor in the predefined set of influence factors.

In block 607, the operations query the primary database 113 to extract influence-related metric data corresponding to the given influence factor of 605 and the particular brand name of 601 and the time window and geographical territory (or collection of territories) related thereto, and use the extracted influence-related metric data to calculate an influence factor score. In such operations, the influence-related metric data stored in the primary database 113 can be filtered to identify the influence-related metric data associated with (or indexed by) brand name, time stamp data, territory identifier data, and possibly other data that matches the particular brand name, time window and geographical territory and possibly other parameters of the query.

In block 609, the operations iterate through the loop of blocks 605 to 609 for next influence factor until the loop is complete.

In block 611, the operations use the influence factor scores of 609 corresponding to the predefined set of influence factors and corresponding weights based on brand category to calculate a total influence score for the particular brand of 601 and the relevant time period and geographical territory (or collection of territories). The weights can be configured to specify the relative weight of the influence factor scores on the resultant influence score. For example, the weights can be configured to give some of the influence factor scores more, the same, or less “weight” or influence on the resultant influence score than other influence factor scores in the same set.

In block 613, the operations query the primary database 113 to extract total-exposure-related metric data corresponding to the particular brand name of 601 and the relevant time window and geographical territory (or collection of territories), and use the extracted total-exposure-related metric data to calculate a relevant-territory total exposure score. In such operations, the total-exposure-related metric data stored in the primary database 113 can be filtered to identify the total-exposure metric data associated with (or indexed by) brand name, time stamp data, territory identifier data, and possibly other data that matches the particular brand name, time window and geographical territory and possibly other parameters of the query.

In block 615, the operations adjust the relevant-territory total exposure score of 613 based on social media metric data pertaining to the particular brand name of 601 and the time window and geographical territory (or collection of territories) related thereto. In embodiments, the social media metric data can be based on sentiment analysis of brand mentions in one or more social media channels performed by one or more third-party data providers. For example, the social media channels can include Facebook, Twitter, Instagram, Youtube and other social media sources. The social media metric data can be stored as source data in one or more data sources in association with the particular brand name and corresponding time stamp. In embodiments, the source data can be accessed and stored by the data collection server 103 and transformed for storage as brand-specific social media metric data of the defined format (e.g., dimensions and indexes) of the primary database 113 as part of data collection/transformation process (e.g., FIG. 2). The brand-specific social media metric data stored in the primary database 113 can be filtered to identify the social media metric data associated with (or indexed by) the brand name, time stamp data, territory identifier data, and possibly other data that matches the particular brand name, time window and geographical territory and possibly other parameters of the query. The matching social media metric data can be used to adjust the relevant-territory total exposure score of 613, for example, as described below with respect to Eqn. (3).

In block 617, the operations use the adjusted relevant-territory total exposure score of 615 and the total influence score of 611 to generate a brand score for the particular brand name of 601 and the time window and geographical territory (or collection of territories) related thereto.

Note that the operations of FIGS. 6A, 6B and 6C can be performed separately for different brand names to generate brand score for the brand names and the time window and geographical territory (or collection of territories) related thereto.

Furthermore, the data processing operations of FIGS. 6A, 6B and 6C can be performed separately for different brand names for different geographical territories and/or over different time windows to generate brand score for the brand names for the different geographical territories and/or over the different time windows.

In embodiments, the relevant time window of the data processing operations of FIGS. 6A, 6B and 6C can cover multiple time periods as associated with the metric data in the primary database. In this case, the influence factor scores for the given brand name and the relevant geographical territory and the relevant time window can be based on averaging or combining extracted influence-related metric data that corresponds to the multiple time periods. Alternatively, the influence score for the given brand name and the relevant geographical territory and the relevant time window can be based on averaging or combining influence scores that correspond to the multiple time periods. Furthermore, the exposure score for the given brand name and the relevant geographical territory and the relevant time window can be based on averaging or combining extracted exposure-related metric data that corresponds to the multiple time periods. Alternatively, the exposure score for the given brand name and the relevant geographical territory and the relevant time window can be based or based on averaging or combining exposure scores that correspond to the multiple time periods. And furthermore, the brand score for the given brand name and the relevant geographical territory and the relevant time window can be based on the influence score that covers the multiple time periods and the exposure score that covers the multiple time periods. Alternatively, the brand score for the given brand name and the relevant geographical territory and the relevant time window can be based on averaging or combining brand scores that correspond to the multiple time periods.

In embodiments, as part of block 611, the influence factor scores for a given brand name can be weighted and combined to generate a total influence score Ī_{w}_{ᵢ} for a brand name (i.e., a specific brand name with index i in a set of competitor brands) and the relevant geographical territory and one or more time periods that cover the relevant time window, using the following example formula:

$${\overline{I}}_{{w}_{i}} = \frac{{\sum }_{j = 1}^{n} ( {I}_{j} * {w}_{j} )}{{\sum }_{j = 1}^{n} {w}_{j}} , \qquad Eqn . ( 1 )$$

where Ī_{w}_{ᵢ} is the total influence score for the given brand name (with index i) and the relevant geographical territory and one or more time periods that cover the relevant time window,
   Iⱼ is the influence factor score for a respective influence factor j=1 . . . n, and
   wⱼ is the weight or weighting factor corresponding to the respective influence factor j=1 . . . n.
      In embodiments, the weight wⱼ can be based on a percentage of the traffic share of influence for a particular brand category and geographical territory and one or more time periods.

In embodiments, as part of blocks 613 and 615, the exposure score θᵢ for the given brand name (with index i) and the relevant geographical territory and one or more time periods that cover the relevant time window can be calculated using the following formula:

$${θ}_{i} = \frac{{E}_{i} - \tilde{E}}{{E}_{max} - \tilde{E}} , \qquad Eqn . ( 2 )$$

where θᵢ is the exposure score for the given brand name (with index i) and the relevant geographical territory and one or more time periods that cover the relevant time window;
   Eᵢ is based on monetary expenditures associated with the given brand name (with index i) over the relevant geographical territory and one or more time periods that cover the relevant time windows,
   Eₘₐₓ is based on maximum monetary expenditures associated with the set of competitor brand names over the relevant time period and geographical territory, and
   \tilde{E} is based on median monetary expenditures associated with the set of competitor brand names over the relevant time period and geographical territory.

In embodiments, Eᵢ of Eqn. (2) can be further based on at least one social media metric for the given brand name and geographical territory and time period, such as number of mentions in a month in a geographical territory for the given brand name, percentage of positive sentiment mentions in the month and in the geographical territory for the given brand name, and percentage of negative sentiment mentions in the month in and the geographical territory for the given brand name. For example, Eᵢ can be calculated according to the following example formula:

Eᵢ=(1−Mᵢsᵢ)Eᵢ*,

sᵢ=sᵢ^{P}−sᵢ^{N} Eqn. (3)
where Eᵢ* represents the total unadjusted expenditures (monies) spent on a given brand name (with index i),
   Mᵢ represent the total number of mentions in one or more social media channels in the last month in a geographical territory for the given brand name (with index i),
   sᵢ^{P} represents the percentage of positive sentiment mentions for the last month in a geographical territory for the given brand name (with index i),
   sᵢ^{N} represents the percentage of negative sentiment mentions for the last month in a geographical territory for the given brand name (with index i).

In embodiments, as part of block 617, the brand score A_{score} for the given brand name and the relevant geographical territory and one or more time periods that cover the relevant time window can be calculated using the following example formula:

$${A}_{{score}_{i}} = \frac{{I}_{{E}_{i}} - {\overline{I}}_{{w}_{i}}}{{n}_{v}} , \qquad Eqn . ( 4 )$$

Where A_{score}_{ᵢ} is the brand score for the given brand name (with index i) and the relevant geographical territory and one or more time periods that cover the relevant time window,
   Ī_{w}_{ᵢ} is the influence score for the given brand name (with index i) and the relevant geographical territory and one or more time periods that cover the relevant time window from Eqn. (1),
   I_{E}_{ᵢ} is an expected influence score for the given brand name (with index i) and the relevant geographical territory and one or more time periods that cover the relevant time window based on the exposure score for the given brand name and the relevant geographical territory and one or more time periods that cover the relevant time window, and
   nᵥ is a sample size.

In embodiments, the expected influence score Ī_{E}_{ᵢ} of Eqn. (4) for a given brand name (with index i) and relevant time period and geographical territory can be calculated according to the following example formula:

$${I}_{{E}_{i}} = \frac{N}{2} - ( {θ}_{i} * \frac{N}{2} ) , \qquad Eqn . ( 5 )$$

where N is the number of brand names in the set of competitor brand names, and
   θᵢ is the exposure score calculated for the given brand name (with index i) and the relevant geographical territory and one or more time periods that cover the relevant time window from Eqn. (2).

In embodiments, the brand score for the given brand name as calculated by Eqn. (4) can have a range from −1 to +1 or 0 to 100.

In embodiments, the systems and methods can rank the set of competing brand names based on the brand scores as calculated for the set of competing brand scores. The ranking for the set of competing brand names can involve converting the brand scores into ranking scores in the range of 0 to 100.

In alternate embodiments, the total unadjusted expenditures (monies) Eᵢ* of Eqn. (3), or possibly the expenditures (monies) Eᵢ of Eqn. (2), can be adjusted to account for effort of the brand owner or agent in increasing the share of total market of the particular brand name as well as actual changes or variation of the share of total market of the particular brand name over time. Note that the share of total market for a particular brand name is related to share of voice (SOV) for the particular brand name but it is not the same. Share of voice relates the particular brand name's percentage of total spending for the brand category for a specific time period. The share of voice of particular brand names can be provided by different data sources for different geographical territories. For example, share of voice data for particular brand names in the United States is provided by Neilson, while share of voice data for particular brand names in Canada is provided by Numerator. Whilst the present market believes there is a direct correlation between share of voice as it pertains to a particular brand name and associated brand category to the percentage or share of the particular brand name in the total marketplace of the brand category, this is simply is no longer true. That said, effectiveness and efficiency of the expenditures associated with a brand name can be accurately measured for its contribution toward the brand name's share of total market in an associated brand category because the contributions of other “influence” factors (i.e., digital media channels) are now accounted for in their overall contribution to market share or share of total market. Specifically, adjustments to the expenditures (monies) Eᵢ* can be configured such that the resulting adjusted expenditure data Eᵢ* reflects effectiveness of the advertising resulting from the total expenditures in the marketplace. For example, the total unadjusted expenditures (monies) Eᵢ* of Eqn. 3 can be substituted with an adjusted expenditure Eᵢ** as follows:

Eᵢ**=Eᵢ*·E_{F}, Eqn. (6)
where Eᵢ* is the total unadjusted expenditures (monies) of Eqn. (3). and
   E_{F} is an effectiveness factor based on a share of total market parameter STM_{E} and a share of total market parameter STM_{VAR}, where STM_{E} reflects current effort of the brand owner or agent in increasing share of the particular brand name in the total market of the brand category, and STM_{VAR} reflects actual changes or variation of the share of the particular brand name in the total market of the brand category over time.

In embodiments, the effectiveness factor can be configured to adjust the exposure or expenditures (monies) that influence the brand score for a particular brand name in a manner that rewards expenditures that contribute to the brand's market share gain over time (for example, month to month) and that penalizes expenditures that contribute to the brand's market share loss over time (for example, month to month). Thus adjustment allows the resultant brand score to reflect an increase, stagnant or decline in ROI pertaining to in market investment to market share.

In embodiments, the STM_{VAR} parameter can be defined by two time-blocks that correspond to the time window of the brand scoring analysis. For example, when the time window of the brand scoring analysis is a year, the time period for STM_{VAR} parameter can encompass two years (the previous year and the current year of the time window) for a year-to-year comparison. In another example, when the time window of the brand scoring analysis is a month, the time period for STM_{VAR} parameter can encompass two months (the previous month and the current month of the time window) for a month-to-month comparison.

In embodiments, the effectiveness factor E_{F} can be calculated as:

$${E}_{F} = \frac{{STM}_{E}}{{STM}_{VAR}} / \frac{\overline{{STM}_{E}}}{\overline{{STM}_{VAR}}} , \qquad Eqn . ( 7 )$$

where STM_{E} is determined from the ratio TME/MS, where TME is the total media expenditures (in all media channels) for the particular brand name in the time window and geographical territory of the brand scoring analysis, and MS is market share of the particular brand name in its associated brand category for the time window and geographical territory of the brand scoring analysis;
   STM_{VAR} is determined from the ratio TME′/MS′, where TME′ is the total media expenditures (in all media channels) for the particular brand name in a relevant time period (e.g., two time blocks) for the time window and the geographical territory of the brand scoring analysis, and MS' is the market share of the particular brand name in its associated brand category for the relevant time period (e.g., two time blocks) of the time window and geographical territory of the brand scoring analysis;
   S̅Y̅M̅_̅{̅E̅}̅ is determined from the maximum (or the 75% mean or other statistically relevant parameter) of the STM_{E} values for the set of competing brand names of the brand scoring analysis; and

\sqrt{STM_{VAR}} is determined from the maximum (or the 75% mean or other statistically relevant parameter) of the STM_{VAR} values for the set of competing brand names of the brand scoring analysis.

The market share (MS) of a particular brand name is a measure of the consumers' preference for product(s) that are branded by the particular brand name over other similar or competing products. Market share can be expressed as a function of value (typically sale revenue) or volume (typically sales volume). For example, value market share can be based on the sales revenue for product(s) that are branded by the particular brand name as part of total sales revenue for the related set of similar or competing products. In another example, volume market share can be based on the sales volume for product(s) that are branded by the particular brand name as part of total sales volume for the related set of similar or competing products. The relationship between value market share and volume market share is not always linear, which means that value market share may be high, but volume market share may be low, or vice versa. In industries like fast moving consumer goods where the products are low value, high volume, evaluation of value market share is the norm.

The total media expenditure data (e.g., TME and TME′) and market share data (e.g., MS and MS′) for the particular brand name can be provided by the brand owner or agent or from a specific vendor. The total media expenditure data and market share data for the other competing brands in a brand category can be provided by a particular data source or vendor as deemed appropriate. The data source(s) for the total media expenditure data and market share data for the particular brand name can include one or more public online databases (which can be accessed via an API), one or more private online databases (which typically require a subscription or other commercial arrangement with the database provider for access via an API), other web services, one or more offline databases, manual data input (such as importation of spreadsheet data or other formatted data), and possibly other data sources. Different data source vendors can provide total media expenditure data and market share data for different brand categories. For example, Neilson (https://www nielsen.com/) can provide total media expenditure data and market share for brand categories related to consumer packaged goods, while Goodcar/Badcar (https://www.goodcarbadcar.net) can provide total media expenditure data and market share for automotive brand categories.

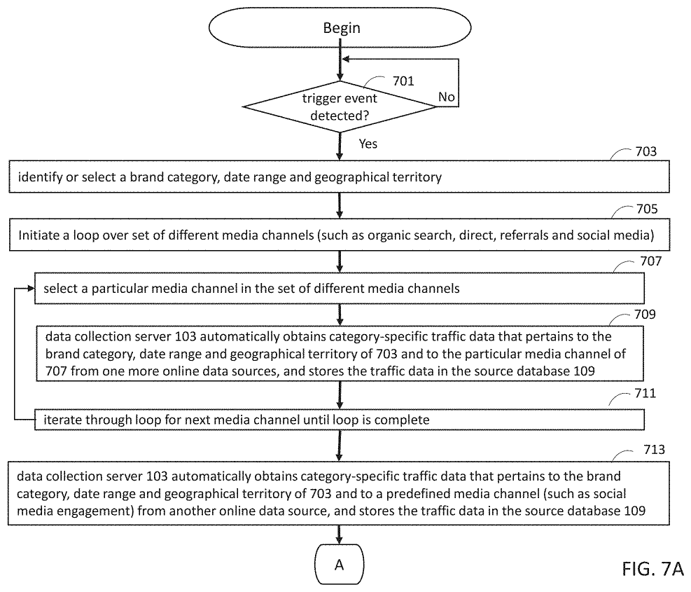

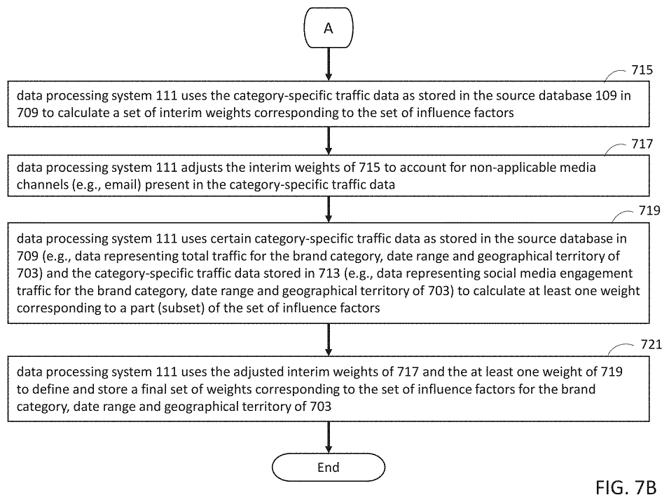

FIGS. 7A and 7B illustrate exemplary operations that calculate the set of weights corresponding to different influence factors for use in the brand scoring calculations of FIGS. 6A, 6B and 6C. The process begins in block 701 by checking whether a trigger event has been detected or activated. If so, the operations continue to block 703 to 721. The trigger events can include one or more time-based scheduled events. Alternatively or additionally, the trigger events can involve predefined user-input operations. In embodiments, the triggering event can involve predefined manual user-input operations that are performed by the user based on availability of source data and/or time windows best suited for the needs of the client or brand owner.

In block 703, the operations identify or select a brand category, a date range, and a geographical territory.

In block 705, the operations perform a loop (blocks 707-711) over a predefined set of different media channels (such as organic search, direct, referrals and social media).

In block 707, the operations identify or select a particular media channel in the predefined set of media channels.

In block 709, the data collection server 103 automatically obtains category-specific traffic data that pertains to the brand category, date range and geographical territory of 703 and to the particular media channel of 707 from one more online data sources, and stores the traffic data in the source database 109.

In block 711, the operations iterate through the loop of blocks 707 to 711 for next media channel until the loop is complete.

In block 713, the data collection server 103 automatically obtains category-specific traffic data that pertains to the brand category, date range and geographical territory of 703 and to a predefined media channel (such as social media engagement) from another online data source, and stores the traffic data in the source database 109.

In block 715, the data processing system 111 uses the category-specific traffic data as stored in the source database 109 in 709 for the predefined set of different media to calculate a set of interim weights corresponding to the set of influence factors.

In block 717, the data processing system 111 adjusts the interim weights of 715 to account for non-applicable media channels (e.g., email) present in the category-specific traffic data.

In block 719, the data processing system 111 uses certain category-specific traffic data as stored in the source database in 709 (e.g., data representing total traffic for the brand category, date range and geographical territory of 703) and the category-specific traffic data stored in 713 (e.g., data representing social media engagement traffic for the brand category, date range and geographical territory of 703) to calculate at least one weight corresponding to a part (subset) of the set of influence factors.

In block 721, the data processing system 111 uses the adjusted interim weights of 717 and the at least one weight of 719 to define a final set of weights corresponding to the set of influence factors for the brand category, date range and geographical territory of 703. The final set of weights corresponding to the set of influence factors can be stored in the primary database 113 in association with the brand category, date range and geographical territory as identified or selected in 703.

Note that the operations of FIGS. 7A and 7B can be performed separately for different brand categories, different date ranges, different geographical territories and for combinations of these dimensions.

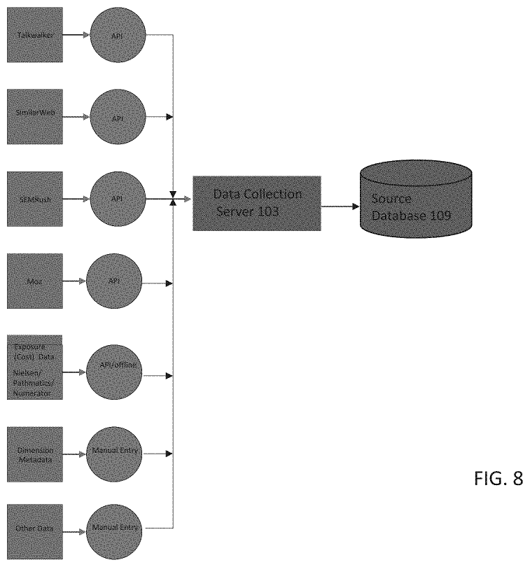

As described herein, the influence-related source data obtained from the data sources (as well as the scoring process based thereon) pertain to a predefined set of influence factors, which relate to different aspects or domains as to how a brand influences consumer behavior or emotions in different media channels of the marketplace. In one exemplary embodiment, the predefined set of influence factors include four influence factors referred to as Brand Interest, Brand Presence, Brand Relevance, and Brand Advocacy. Brand Interest relates to how a brand influences consumer search behavior. For example, Brand Interest can provide an indication of organic search influence of an input domain/website based on traffic received from all organic keywords from organic searches. Organic search is a method for entering one or several search terms as a single string of alphanumeric characters into a search engine. Brand Presence relates to how a brand influences consumer keyword searching. For example, Brand Presence can provide an indication of positioning influence of an input keyword based on effort required to secure top ranking for the keyword in organic search results. Brand Relevance relates to how a brand influences consumer behavior on the web. For example, Brand Relevance can provide an indication of web influence of and input domain based on visit (quantity) and engagement (quality) of users. Brand Advocacy relates to how a brand influences consumer social behavior on the web. For example, Brand Advocacy can provide an indication of social influence of an input keyword based on sentiment of the keyword across various online social channels. Different data sources can store the influence-related source data pertaining to the four influence factors as summarized in FIG. 8. In this example, the SEMRush Database, which is available from semrush.com and provided by Semrush, Inc. of Boston, Ma stores influence-related source data pertaining to Brand Interest. The Moz Database, which is available from moz.com provided by Moz, Inc. of Seattle, Wash., stores influence-related source data pertaining to Brand Presence. The SimilarWeb Database, which is available from similarweb.com and provided by SimilarWeb Ltd. Of Tel Aviv, Israel, stores influence-related source data pertaining to Brand Relevance. The Talkwalker database, which is available from talkwalker.com and provided by Talkwalker Inc. of NY, N.Y., stores influence-related source data pertaining to Brand Advocacy.

These data sources (e.g., SEMRush, Moz, SimilarWeb, and Talkwalker) can be accessed by the data collection server 103 to extract and obtain the influence-related source data pertaining to the corresponding influence factors (e.g., Brand Interest, Brand Presence, Brand Relevance, and Brand Advocacy) for a given brand name. In other embodiments, one or more data sources can store the influence-related source data pertaining to multiple influence factors e.g., Brand Interest, Brand Presence, Brand Relevance, and Brand Advocacy) for a given brand name. In still other embodiments, a single data source can store the influence-related source data pertaining to the influence factors (e.g., Brand Interest, Brand Presence, Brand Relevance, and Brand Advocacy) for a given brand name. Various parameters or constraints for extracting the influence-related source data from the data sources can be defined by parameters or other data stored in a control table or other data structure.

In embodiments, the influence-related source data for a given brand name can be obtained in an automatic manner from the data sources (e.g., SEMRush, Moz, SimilarWeb, and Talkwalker) via corresponding online application programming interfaces (APIs). For example, the data collection server 103 of FIG. 8 can be configured to access a particular data source via a predefined online API for that data source, where the online API involves data communication over the Internet to automatically extract and obtain influence-related source data stored by the data source that pertains to a given brand name. The operations of the data collection server that use the online API can be initiated in an automatic programmed manner by automated detection of one or more trigger events or conditions. Some of the parameters for accessing the data sources can be specified by manual entry or other user input. Parameters of the online API for a particular data source as well as parameters for the trigger events or conditions can be stored in a control table or other data structure and accessed by the data collection server 103 to generate a script that carries out the operations of the data collection server 103 that use the online API to automatically extract and obtain the influence-related source data that pertains to a brand name from the appropriate data source through data communication over the Internet. The obtained influence-related source data can be stored with time-stamp data and a territory identifier. The time stamp data can represent a time period corresponding to the exposure-related source data associated therewith. The time-stamp data, for example, can represent a start date and end date. The time period represented by the time-stamp data can represent a day, month, year, or other period of time. The territory identifier can identify a particular geographical territory, such as country, region, state, or other geographical territory. Such operations can be performed to obtain and store influence-related source data that pertains to different geographical territories (such as countries, regions, states, etc.) for a given time period. Such operations can be repeatably performed over time to obtain and store influence-related source data that pertains to different geographical territories and/or different time periods for a given brand name. Furthermore, such operations can be performed separately for each brand name in a set of competing brand names.

In embodiments, scripts or other programming constructions can be configured to access such data and combine the data with brand-specific information (such as brand name and associated domain) and a date range, geographical territory, or possibly other parameters to generate requests or other messages that conform to predefined online APIs for the respective data sources. The requests or messages are communicated between the data collection server 103 and the respective data sources to extract and obtain the influence-related source data pertaining to the corresponding influence factors (Brand Interest, Brand Presence, Brand Relevance, and Brand Advocacy) for storage in the source database 109. Example scripts for generating online API requests or messages for the four influence factors (Brand Interest, Brand Presence, Brand Relevance, and Brand Advocacy) are presented below.

Script for Brand Interest Influence Factor—extracts influence-related source data from SEMRush Database
Category_SEMRushAPI_ADD.txt
echo $(curl −X GET “https://api.semrush.com/
?type::phrase_kdi
&key=<accesskey>
&export columns=Ph,Kd
&phrase=<brands>
&database=<territory>”)
>${OUTPUT1_STAGING_DIR}/Category_SEMRushAPI_ADD_$(date +% Y % m % d_% H % M).json
   Script for Brand Presence Influence Factor—extracts influence-related source data from Moz Database
Category_MozAPI_ADD.txt
echo $(curl −X POST “https://mozscape-<accesskey>@1sapi.seomoz.com/v2/url_metrics
{“targets”: [<brandwebsites>] }”)
>$(OUTPUT1_STAGING_DIR)/Category_Moz_ADD_$(date +% Y % m % d_% H % M).json
   Script for Brand Relevance Influence Factor—extracts influence-related source data from SimilarWeb Database
Category_SimilarWebAPI_Visits_ADD.txt
echo $(curl −X GET
‘https://api.similarweb.com/v1/website/<brandwebsites>/total-traffic-and-engagement/visits
?api_key=<accesskey>
&start_date=<YYYY-MM>&end_date=<YYYY-MM>
&country=<territory>
&granularity=monthly&main_domain_only=false&format=json&show_verified=false’)
>$(OUTPUT1_STAGING_DIR)/Category_SimilarWebAPIVisits_ADD_$(date +% Y % m % d_H % M).json
   Script for Brand Advocacy Influence Factor—extracts influence-related source data from Talkwalker Database
Category_TalkwalkerAPI_Engagement_ADD.txt
echo $(curl −X GET
‘https:/api.talkwalker.com/api/v1/search/histogram/engagement
?access_token=<accesskey>
=<brand-category-territory-published-list>
${OUTPUT1_STAGING_DIR}/Category_TalkWalkerAPIEngagement_ADD_$(date % Y % n % d_H % M).json
Category_TalkwalkerAPI__Sentiment_ADD.txt
echo $(curl −X GET ‘https://api.talkwalker.com/api/v1/search/histogram/sentiment
?access_token=<accesskey>
=<brand-category-territory-published-list>
${OUTPUT1_STAGING_DIR}/Category_TalkWalkerAPlSentiment_ADD_$(date+% Y % m % d_% H % M).json

Note that the script for Brand Presence Influence Factor need not include a parameter that specifies a geographical territory. In this case, the relevant geographical territory can be inferred from the location of the domain name specified by the script.

Furthermore, the scripts can be used to extract traffic data from the SimilarWeb Database and the Talkwalker Database, and the extracted traffic data can be used in calculating a set of category-specific weights for the four influence factors (Brand Interest, Brand Presence, Brand Relevance, and Brand Advocacy) for different brand categories and date ranges and geographical territories in the manner described above in FIGS. 7A and 7B. Table A below illustrates exemplary data collection operations and calculations of a set of category-specific weights according to the process of FIGS. 7A and 7B for four influence factors (Brand Interest (I1), Brand Presence (I2), Brand Relevance (I3), and Brand Advocacy (14)) for an example brand category of “Furniture” in the geographical territory of the “United States” for the Date Range of Apr. 1, 2020 to Apr. 30, 2020. Similar operations can be performed for the same brand category (or different brand category) in different geographical territories and/over different data ranges.

TABLE A

| Block(s) | Note | Example Results |
|---|---|---|
| 705-711 | Traffic analytics data source: | collected category-specific, |
| collect | SimilarWeb | geo-specific and time- |
| category- | Media Channels: organic | specific traffic share data |
| specific, geo- | search, direct, referrals, | by media channel organic |
| specific and | social | search traffic share: |
| time-specific | Category: Furniture | 34.54% |
| traffic share | Geography: US | Direct traffic share: |
| data by media | Time: April 2020 | 30.56% |
| channel from | | Referral traffic share: |
| traffic | | 4.66% |
| analytics data | | Social traffic share: 5.09% |
| source | | |
| 713 | Traffic analytics data source: | collected category-specific, |
| collect | SimilarWeb | geo-specific and time- |
| category- | Total traffic data across | specific total traffic share |
| specific, geo- | category universe used to | data: 89.63M |
| specific and | represent total traffic share | |
| time-specific | Category: Furniture | |
| total traffic | Geography: US | |
| data from | Time: April 2020 | |
| traffic | | |
| analytics data | | |
| source | | |
| 715 | Social Engagement data | collected category-specific, |
| collect geo- | source: Talkwalker | geo-specific and time- |
| specific and | Social engagement data used | specific social engagement |
| time-specific | to represent social traffic | traffic share data: 2.8M |
| social | share to account for | |
| engagement | potential under- | |
| data with | representation of social in | |
| category- | total traffic share data in | |
| determining | Similar Web | |
| query from | Category: Furniture | |
| social | Geography: US | |
| listening data | Time: April 2020 | |
| source | | |
| 717 | Interim weight for I1 = | Interim weight for I1: |
| Determine | organic search traffic share/2 | 17.27% |
| interim | Interim weight for I2 = | Interim weight for I2: |
| weights for | organic search traffic share/2 | 17.27% |
| the influence | Interim Weight for I3 = | Interim weight for I3 = |
| factors I1, I2, | direct traffic share + referral | 30.56% + 4.66% = 35.22% |
| I3 and I4 from | traffic share | Interim weight for I4 = |
| the collected | Interim Weight for I4 = | 5.09% |
| traffic share | social traffic share | Total Interim Weights = |
| data of 705- | | 17.27% + 17.27% = |
| 711 | | 35.22% + 5.09% = 74.85% |
| 719 | Re-weighting to provide | Adjusted Interim weight |
| adjust or re- | 100% total weights in order | for I1 = 17.27% * |
| weight | to account for exclusions of | (100%/74.85%) = |
| interim | other non-applicable | 23.075% |
| weights | channels in the traffic | Adjusted Interim weight |
| | share data (e.g., email) | for I2 = 17.27% * |
| | | (100%/74.85%) = |
| | | 23.075% |
| | | Adjusted Interim weight |
| | | for I3 = 35.22% * |
| | | (100%/74.85%) = 47.05% |
| | | Adjusted Interim weight |
| | | for I4 = 5.09% * |
| | | (100%/74.85%) = 6.80% |
| | | Total Adjusted Interim |
| | | Weights = 23.075% + |
| | | 23.075% + 47.05% + |
| | | 6.80% = 100% |
| 721 | | Final Weight for I1 = |
| assign the | | Adjusted Interim weight |
| adjusted the | | for I1 = = 23.075% |
| interim | | Final Weight for I2 = |
| weights for I1 | | Adjusted Interim weight |
| and I2 to the | | for It = = 23.075% |
| final weights | | |
| for I1 and I2 | | |
| 723 | Secondary interim weight | Secondary interim weight |
| calculate | for I3 = ((total traffic data − | for I2 = ((89.63M − |
| secondary | engagement traffic | 2.8M)/89.63M)*100 = |
| interim | data)/total traffic data)*100 | 96.88% |
| weights | Secondary interim weight | Secondary interim weight |
| for I3 and I4 | for I4 = (engagement traffic | for I4 = |
| based on the | data/total traffic data)*100 | (2.8M/89.63M)*100 = |
| total traffic | | 3.1% |
| data and the | | |
| social | | |
| engagement | | |
| traffic data | | |
| collected in | | |
| 713 and 715 | | |
| 725 | Remaining Total % of the | Remaining Total % of the |
| Reweight the | Weights for I3 and I4 = | Weights for I3 and I4 = |
| secondary | 100 − Final Weight for I1 − | 100% − 23.075% − |
| interim | Final Weight for I2 | 23.075% = 53.85% |
| weight based | Final Weight for I3 = | Final Weight for I3 = |
| on the weights | (Secondary interim weight | 96.88% * (53.85%/ |
| of 721 to | for I3) * (Remaining Total | 100%) = 52.18% |
| calculate final | % of the Weights s for I3 | Final Weight r for I4 = |
| weights for I3 | and I4/100%) | 3.1% * (53.85%/100%) = |
| and I4 | Final Weight for I4 = | 1.67% |
| | (Secondary interim weight | |
| | for I4) * (Remaining Total | |
| | % of the Weights for I3 and | |
| | I4/100% | |

Category: Furniture Territory: United States Date Range: Apr. 1, 2020 to Apr. 30, 2020

An example script for generating an online API request or message that extracts such data from the SimilarWeb Database follows.

Script for extracting data for weights related to the four influence factors (Brand Interest, Brand Presence, Brand Relevance, and Brand Advocacy) from the SimilarWeb Database
Category Weights_WebsiteOutcome_SimilarWebAPI_ADD.txt
echo $(curl −X GET
‘https://api.similarweb.com/v1/web site/<brandwebsites>/total-traffic-and-engagement/visitsource
?api_key=<accesskey>
&export_columns=search,direct,social
&start_date=<YYYY-MM>&end date=<YYYY-MM>
&country=<territory>
&granularity=monthly&main_domain_only=false&format=json& show_verified=false’)
>
$ {OUTPUT1_STAGING_DIR}/Category_SimilarWebAPIVisitSource_ADD_$(date+% Y % m % d_% H % M).json

As described herein, the exposure-related source data (share of voice or (SV) obtained from the data sources (as well as the scoring process based thereon) can pertain to different media channels in the marketplace as well as to different geographical territories. In one exemplary embodiment, the different media channels can include mass media channels (such as TV, radio, print, and outdoors media) and online digital media channels (such as online video, display, mobile and social media). Different data sources store the exposure-related source data pertaining to the mass media channels and the online digital media channels for different geographical territories as summarized in FIG. 8. For example, consider a scenario for two geographical territories of the United States and Canada. In this case, the exposure-related source data pertaining to mass media channels in the United States for different brands is stored in the Nielsen Database, which is available from nielsen.com and provided by The Nielsen Company (US), LLC. Of N.Y., NY, and the exposure-related source data pertaining to digital online media channels in the United States for different brands is stored in the Pathmatics Database, which is available from pathmatics.com and provided by Pathmatics Inc of Santa Monica, Calif. The exposure-related source data pertaining to mass media channels in Canada for different brands is stored in the Numerator Database, which is available from numerator.com and provided by Market Track, LLC of Chicago, Ill., and the exposure-related source data pertaining to digital online media channels in Canada for different brands is stored in the Pathmatics Database, which is available from pathmatics.com and provided by Pathmatics Inc of Santa Monica, Calif. These data sources (e.g., Nielsen, Pathmatics, Numerator) can be accessed by the data collection server 103 to extract and obtain the exposure-related source data for different media channels (mass market and digital online channels) in the two territories (US and Canada) for a given brand name.

In other embodiments, one or more data sources can store the exposure-related source data pertaining to different media channels (such as mass market media channels and digital media channels) for a given brand name and possibly cover different geographical territories. In still other embodiments, a single data source can store the exposure-related source data pertaining to the pertaining to different media channels (such as mass market media channels and digital media channels) for a given brand name and cover different geographical territories.

In embodiments, the exposure-related source data for a given brand name can be obtained in an automatic manner from the appropriate data source (e.g., Nielsen, Pathmatics, Numerator) via corresponding online APIs. For example, the data collection server 103 of FIG. 8 can be configured to access a particular data source via a predefined online API for that data source, where the online API involves data communication over the Internet to automatically extract and obtain exposure-related source data stored by the data source that pertains to a given brand name. The operations of the data collection server that use the online API can be initiated in an automatic programmed manner by automated detection of one or more trigger events or conditions. Some of the parameters for accessing the data sources can be specified by manual entry or other user input. Parameters of the online API for a particular data source as well as parameters for the trigger events or conditions can be stored in a control table or other data structure and accessed by the data collection server 103 to generate a script that carries out the operations of the data collection server 103 that use the online API to automatically extract and obtain the exposure-related source data that pertains to a brand name from the appropriate data source through data communication over the Internet. The obtained exposure-related source data can be stored with time-stamp data and a territory identifier. The time stamp data can represent a time period corresponding to the exposure-related source data associated therewith. The time-stamp data, for example, can represent a start date and end date. The time period represented by the time-stamp data can represent a day, month, year, or other period of time. The territory identifier can identify a particular geographical territory, such as country, region, state, or other geographical territory. Such operations can be performed to obtain and store exposure-related source data that pertains to different geographical territories (such as countries, regions, states, etc.) for a given time period. Such operations can be repeatably performed over time to obtain and store exposure-related source data that pertains to different geographical territories and/or different time periods for a given brand name. Furthermore, such operations can be performed separately for each brand name in a set of competing brand names.

In embodiments, scripts or other programming constructions can be configured to access parameter data and combine the data with brand-specific information (such as brand name and associated domain) and a date range, geographical territory, or possibly other parameters to generate requests or other messages that conform to predefined online APIs for the respective data sources. The requests or messages are communicated between the data collection server 103 and the respective data source to extract and obtain the exposure-related source data for different media channels (mass market and digital online channels) in the two territories (US and Canada) for a given brand name for storage in the source database 109.

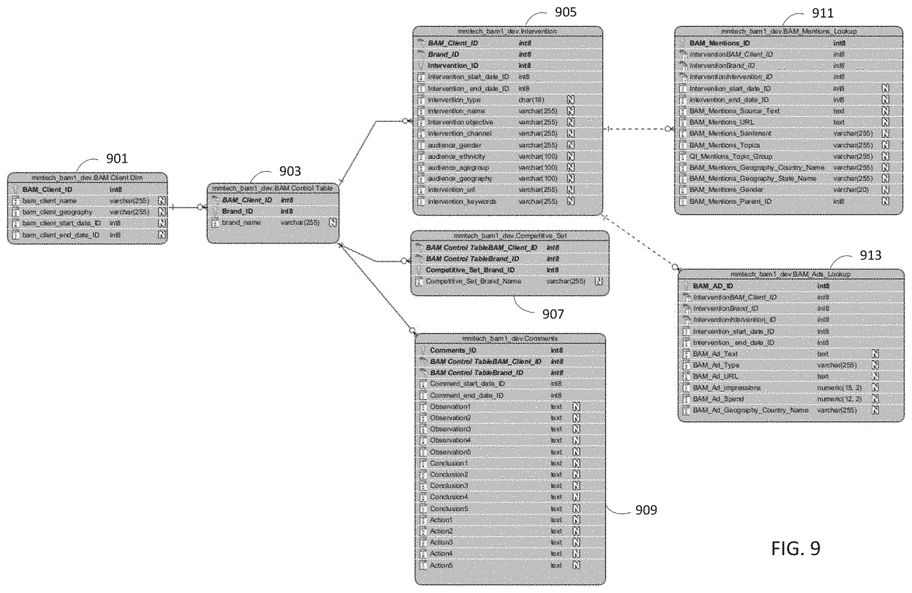

FIG. 9 is a schematic illustration of exemplary database tables that store data pertaining to different brand names that is used in the data collection/transformation process as described herein. The database tables include a client table 901, a control table 903, a campaign table 905, a competitive set table 907, a comments table 909, a mentions-lookup table 911, and an ad-lookup table 913.

The client table 901 stores one or more client-specific data fields associated with a client identifier key. For example, the client-specific data fields can specify a client name, geographical territory, and date range (start date and end date) as shown.

The control table 903 stores one or more brand-specific data fields associated with a client identifier key and a brand identifier key. For example, the brand-specific data fields can specify a brand name. The brand-specific data field(s) of the control table 903 are linked to (and associated with) the client-specific data fields of the client table 901 by the client identifier key.

The campaign table 905 stores data fields related to particular campaign (or intervention) that are associated with a client identifier key, a brand identifier key, and a campaign (or intervention) identifier key. For example, the data fields of the campaign table 905 can include a data range (start date and end date) and meta-data associated with the campaign (such as type, name, channel, demographics such as gender, ethnicity, age group), geographical territory, URL data and keyword data. The data fields of the campaign table 905 are linked to (and associated with) the brand-specific data field(s) of the control table 903 by brand identifier key. The data fields of the campaign table 905 are linked to (and associated with the client-specific data fields of the client table 901 by client identifier key.

The competitive set table 907 stores one or more data fields for a competitive set of brands where the data fields(s) are associated with a competitive set identifier key, a brand identifier key, and a client identifier key. For example, the data field(s) of the competitive set table 907 can specify a competitive set name. The competitor-set-specific data field(s) of the competitive set table 907 are linked to (and associated with) the brand-specific data field(s) of the control table 903 by brand identifier key. This linkage can be provided to different brand identifier keys to define a set of competitive brand names associated with a given competitive set identifier key and corresponding competitive set name.

The comments table 909 stores meta-data fields associated with a comment identifier key, a brand identifier key, and a client identifier key. For example, the meta-data fields of the comment table 909 can include observations, conclusions, and actions. The meta-data fields of the comment table 909 are linked to (and associated with) the brand-specific data field(s) of the control table 903 by brand identifier key. The meta-data fields of the comment table 909 are linked to (and associated with) the client-specific data fields of the client table 901 by client identifier key. In embodiments, the meta-data fields of the comment table 909 can be used to store user-specified data related to a brand name (and client) during performance analysis of the brand name as described herein.

The mentions-lookup table 911 stores meta-data fields related to social media mentions of a brand name. The meta-data fields are associated with a mention identifier key, a brand identifier key, and a client identifier key. For example, the meta-data fields of the mentions-lookup table 911 can include a date range (start date and end date), source text, URL data, sentiment, topics, topic group, geographical territory identifier such as a name or identifier of a country or state, and demographic data such as gender. The meta-data fields of the mentions-lookup table 911 are linked to (and associated with) brand-specific data field(s) of the control table 903 by brand identifier key. The meta-data fields of the mentions-lookup table 911 are linked to (and associated with) the client-specific data fields of the client table 901 by client identifier key. In embodiments, the meta-data fields of the mentions-lookup table 911 can be used to store social media mention data related to a brand name (and client) as derived from relevant online source data as described herein.

The ad-lookup table 913 stores meta-data fields related to advertisements that involve a brand name. The meta-data fields are associated with an advertisement identifier key, a campaign identifier key, a brand identifier key, and a client identifier key. For example, the meta-data fields of the ad-lookup table 913 can include a date range (start date and end date), source text, URL data, type, impression data, spend data, and a geographical territory identifier such as a name or identifier of a country or state. The meta-data fields of the ad-lookup table 913 are linked to (and associated with) brand-specific data field(s) of the control table 903 by brand identifier key. The meta-data fields of the ad-lookup table 913 are linked to (and associated with) the client-specific data fields of the client table 901 by client identifier key. The meta-data fields of the ad-lookup table 913 are linked to (and associated with) campaign-specific data field(s) of the campaign table 905 by campaign identifier key. In embodiments, the meta-data fields of the ad-lookup table 913 can be used to store advertisement data related to a brand name (and client) as derived from relevant online source data as described herein.

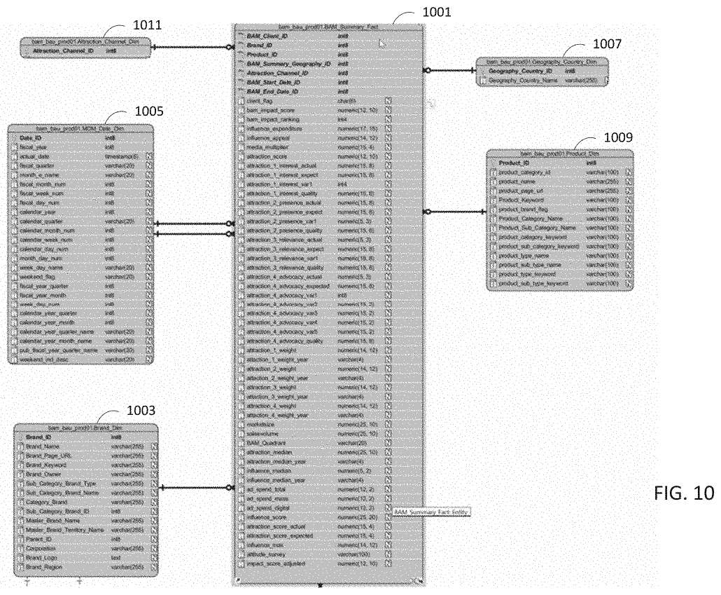

FIG. 10 is a schematic illustration of exemplary database tables that store influence-related metric data and exposure-related metric data as part of the primary database of FIG. 1. The influence-related metric data and exposure-related metric data are derived by transforming the influence-related source data and exposure-related source data stored in the source database 109 through extraction from the data sources shown in FIG. 8. More specifically, the database tables include a summary fact table 1001, a brand dimension table 1003, a date dimension table 1005, a geographical territory dimension table 1007, a product dimension table 1009, and a channel dimension table 1011.

The summary fact table 1001 stores data fields associated with a client identifier key, a brand identifier key, a product identifier key, a geographical territory key, a channel key and a start date key and end date key that specifies a date range. For example, the data fields of the summary fact table 1001 can include i) influence-related metric data and exposure-related metric data for a given brand name that are derived by transforming the influence-related source data and exposure-related source data stored in the source databases 109, ii) the scores and rankings for the brand name that are generated from such metric data (such as influence factor scores, total influence score, exposure score, adjusted exposure score, brand score, ranking); and iii) other data related to the brand name and used in the scoring and performance analysis.

The data fields of the summary fact table 1001 are linked to (and associated with) brand-specific data field(s) of the brand dimension table 1003 by brand identifier key. The data fields of the summary fact table 1001 are linked to (and associated with) the client-specific data fields of the client table 901 of FIG. 9 by client identifier key. The data fields of the summary fact table 1001 are linked to (and associated with) product-specific data field(s) of the product dimensional table 1009 by product identifier key. The data fields of the summary fact table 1001 are linked to (and associated with) geographical-territory-specific data field(s) of the geographical territory dimension table 1007 by geographical territory identifier key. The data fields of the summary fact table 1001 are linked to (and associated with) channel-specific data field(s) of the channel dimension table 1011 by channel identifier key. The data fields of the summary fact table 1001 are linked to (and associated with) date-specific data field(s) of the date dimension table 1005 by date identifier key to specify a start date and end date of a corresponding date range.

The brand dimension table 1003 stores one or more brand-specific data fields associated with a brand identifier key. For example, the brand-specific data fields can include a brand name, URL data related to the brand name, keyword data related to the brand name, the owner of the brand name, a type and name for the category (or subcategory) of the brand name and other data related to the brand name. The data field(s) of the brand dimension table 1003 are linked to (and associated with) the data fields of the summary fact table 1001 by brand identifier key.

The date dimension table 1005 stores one or more date-specific data fields associated with a date identifier key. For example, the date-specific data fields can include a fiscal year, date timestamp, a fiscal quarter, fiscal month, fiscal week, fiscal day, calendar year, calendar quarter, calendar month, calendar week, calendar day, fiscal year and quarter, fiscal year and month, week day, calendar year and quarter, calendar year and month, and possibly other date data. The data field(s) of the date dimension table 1005 are linked to (and associated with) the data fields of the summary fact table 1001 by date identifier key.

The geographical territory dimension table 1007 stores one or more data fields associated with a geographical territory identifier key. For example, the data fields can include a name for a country or other geographical territory. The data field(s) of the geographical territory dimension table 1007 are linked to (and associated with) the data fields of the summary fact table 1001 by geographical territory identifier key.

The product dimension table 1009 stores one or more product-specific data fields associated with a product identifier key. For example, the data fields can include a product category identifier and related category (or subcategory data), a product name, URL data associated with the product name, keyword data associated with the product name or other product related data. The data field(s) of the product dimension table 1009 are linked to (and associated with) the data fields of the summary fact table 1001 by product identifier key.

The channel dimension table 1011 stores one or more data fields associated with a channel identifier key. The data fields of the channel dimension table 1011 are linked to (and associated with) the data fields of the summary fact table 1001 by channel identifier key.

In embodiments, the brand scores for the set of competing brand names can be displayed in a BAM Matrix having an x-axis of Exposure versus a y-axis of Influence into four quadrants:
1. Underperforming/Stagnant—Low exposure, Low attraction
2. Efficient—Low exposure, High attraction
3. Wasteful—High exposure, Low attraction
4. Effective—High exposure, High attraction

As shown in FIG. 11, a display window can be configured to present for display (for example, on the display device of the user device 117A) the BAM Matrix as shown, which includes the competitor set of brand names assigned markers (or other visual elements) at X,Y coordinates based on the calculated scores for the competitor set of brand names as follows:
1. Size (e.g., radius) of the brand marker (or other visual element) is based on the brand score or ranking calculated for the brand name
2. X Axis Position of the brand marker (or other visual element) is based on the total exposure score calculated for the brand name
3. Y Axis Position of the brand marker (or other visual element) is based on the total influence score calculated for the brand name

In embodiments, the brand score (or size of the brand marker) for a given brand name is a measure of how positively a given brand's exposure is related to its influence. A higher brand score indicates that a brand's exposure has been better converted into influence and overall market performance. As a result, the brand score for brand can be declared against the brand scores for key competitor brands based on the weight of influence in relation to exposure.

FIG. 12 illustrates an exemplary graphical user interface (e.g., display window) for user authentication (e.g., block 301) as part of the process of FIGS. 3A and 3B.

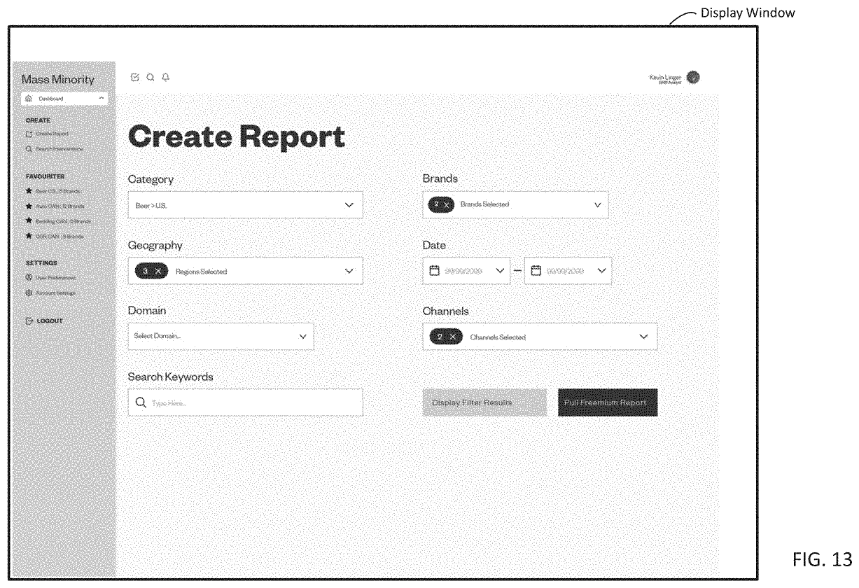

FIG. 13 illustrates an exemplary graphical user interface (e.g., display window) for user input in specifying a brand campaign or brand category (e.g., block 305) as part of the process of FIGS. 3A and 3B. The user interface includes a drop-down menu box (labeled “Category”) that allows the user to select a brand category from a list of brand categories, a drop down menu box (labeled “Brands”) that allows the user to select one or more brand names from a list of brand names, a drop down menu box (labeled “Geography”) that allows the user to select one or more geographical territories from a list of geographical territories, a pair of drop down menu boxes (labeled “Date”) that allows the user to specify a start date and end date for a date range, a drop down menu box (labeled “Domain”) that allows the user to select one or more web site domains from a list of domains, a drop down menu box (labeled “Channels”) that allows the user to select one or more media channels from a list of media channels, and an input text box (labeled “Search Keywords”) that allows the user to input one or more keywords comprising alphanumeric characters. This information can be used to specify the queries of the primary database that extract the relevant metric data that is used for the scoring calculations as part of the process of FIGS. 3A and 3B.

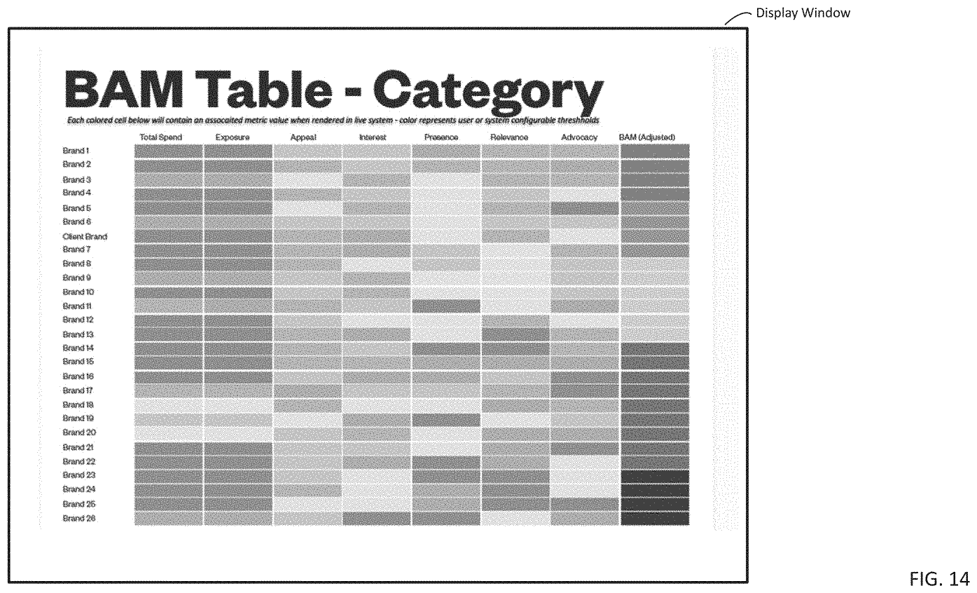

FIG. 14 illustrates an exemplary graphical user interface (e.g., display window) that displays a table based on the results of the process of FIGS. 3A and 3B; the rows of the table correspond to differ brand names, the columns of the table correspond to exposure score, adjusted exposure score, the set of influence factor scores, and the brand score for the different brand names, and the table entries (for each column and row) employ a color scheme that represents the different values of the corresponding scores. The color scheme can be based on user or system configurable thresholds for the scores.

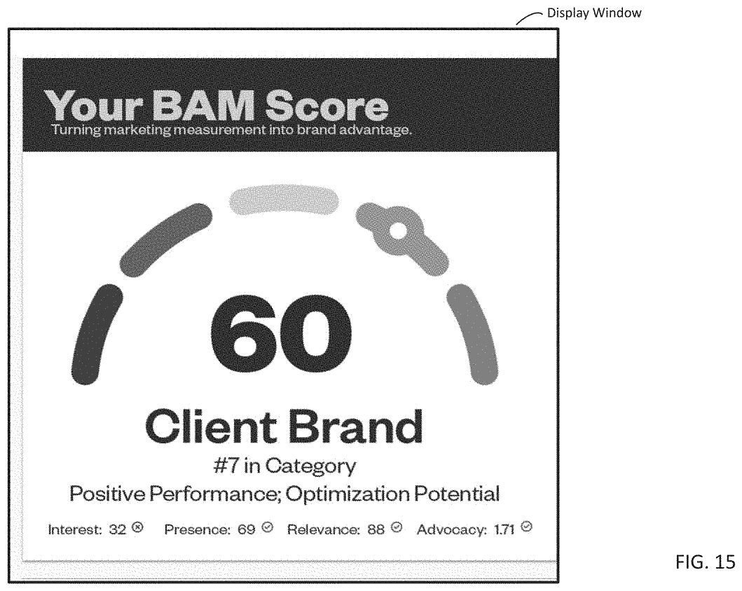

FIG. 15 illustrates an exemplary graphical user interface (e.g., display window) that displays the brand score for a particular brand name along with its ranking in the set of competing brands and the set of influence factor scores for the brand name as produced by the process of FIGS. 3A and 3B.

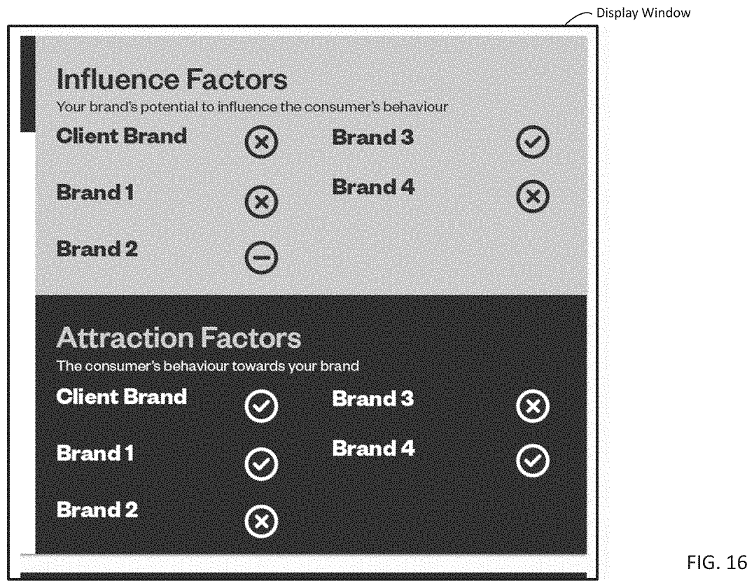

FIG. 16 illustrates an exemplary graphical user interface (e.g., display window) that displays influence indicators as well as attraction indicators for different brand names in the set of competing brand names. The influence indicators (“X”, “−”, or “✓”) are based on the set of influence factor scores for the respective brand name as produced by the process of FIGS. 3A and 3B. The attraction indicators (“X”, “−”, or “✓”) are based on the brand scores for the respective brand name as produced by the process of FIGS. 3A and 3B.

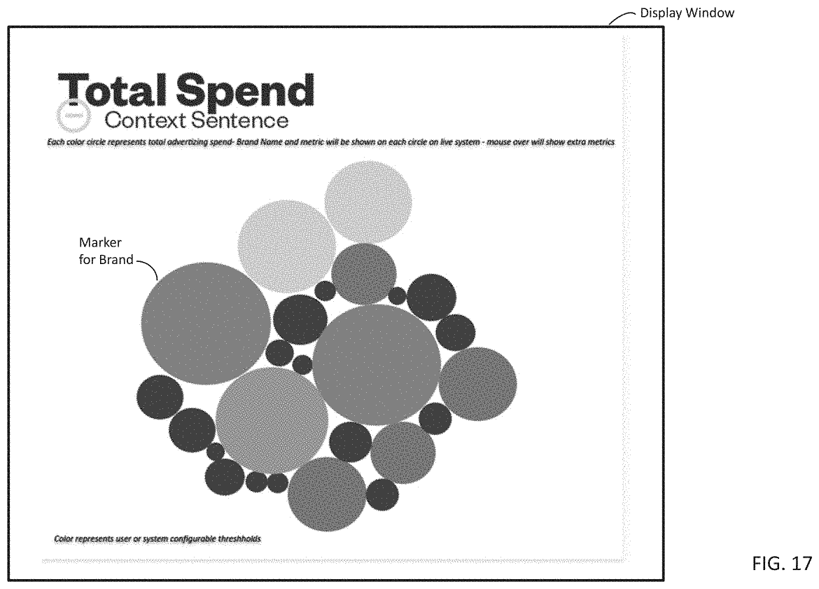

FIG. 17 illustrates an exemplary graphical user interface (e.g., display window) that displays visual markers representing total advertising expenditures (including expenditures for digital media channels and mass media channels) for different brand names as produced by the process of FIGS. 3A and 3B. The sizes (e.g. radius) and colors of the markers are based on the total advertising expenditures for the respective brand names. The color scheme can be based on user or system configurable thresholds for the total advertising expenditures.

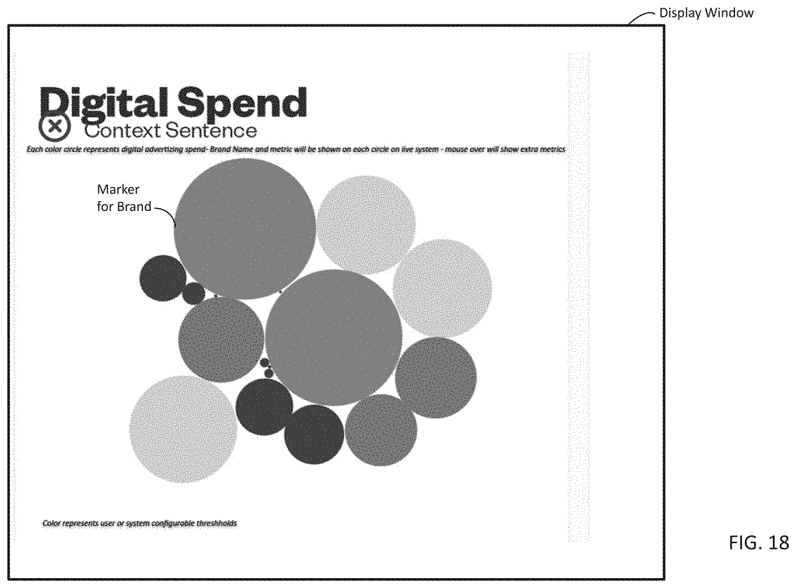

FIG. 18 illustrates an exemplary graphical user interface (e.g., display window) that displays visual markers representing advertising expenditures in digital media channels for different brand names as produced by the process of FIGS. 3A and 3B. The sizes (e.g. radius) and colors of the markers are based on the advertising expenditures in digital media channels for the respective brand names. The color scheme can be based on user or system configurable thresholds for the digital media channel advertising expenditures.

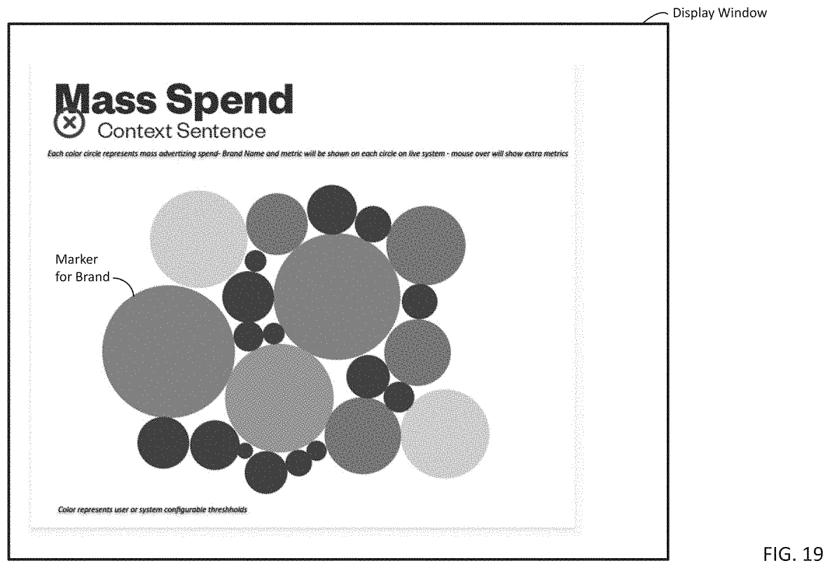

FIG. 19 illustrates an exemplary graphical user interface (e.g., display window) that displays visual markers representing advertising expenditures in mass media channels for different brand names as produced by the process of FIGS. 3A and 3B. The sizes (e.g. radius) and colors of the markers are based on the advertising expenditures in mass media channels for the respective brand names. The color scheme can be based on user or system configurable thresholds for the mass media channel advertising expenditures.

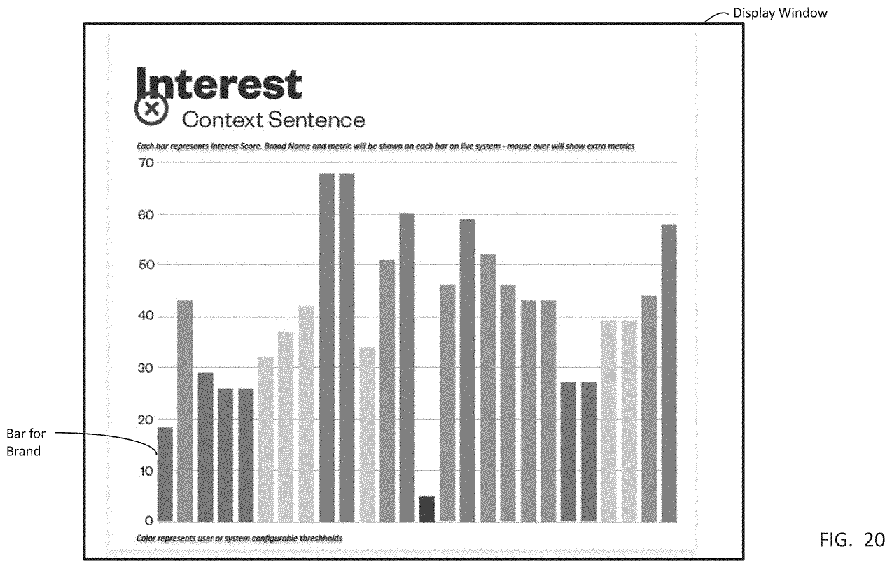

FIG. 20 illustrates an exemplary graphical user interface (e.g., display window) that displays bars representing Brand Interest factor scores for different brand names as produced by the process of FIGS. 3A and 3B. The length of the bars and colors of the bars are based on the Brand Interest factor scores for the respective brand names. The color scheme can be based on user or system configurable thresholds for the Brand Interest factor scores.

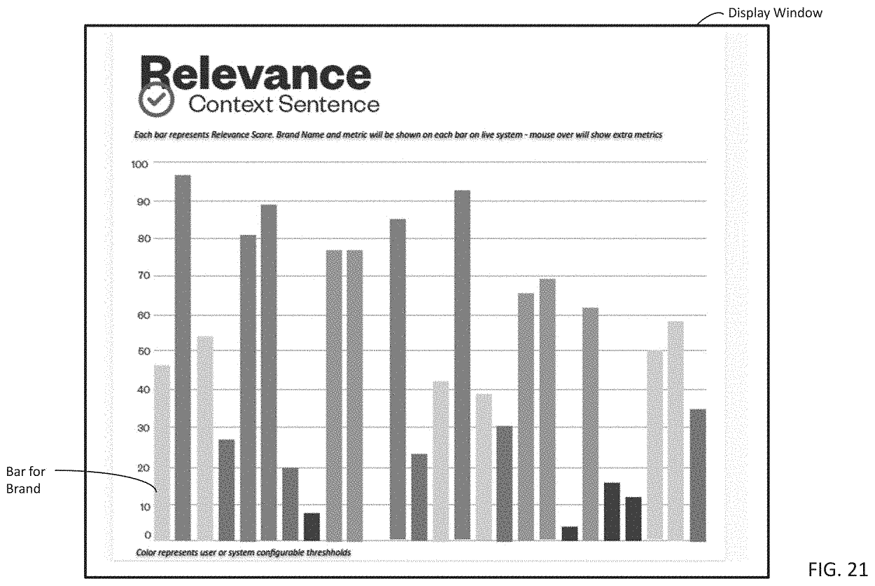

FIG. 21 illustrates an exemplary graphical user interface (e.g., display window) that displays bars representing Brand Relevance factor scores for different brand names as produced by the process of FIGS. 3A and 3B. The length of the bars and colors of the bars are based on the Brand Relevance factor scores for the respective brand names. The color scheme can be based on user or system configurable thresholds for the Brand Relevance factor scores.

FIG. 22 illustrates an exemplary graphical user interface (e.g., display window) that displays bars representing Brand Presence (or Appeal) factor scores for different brand names as produced by the process of FIGS. 3A and 3B. The length of the bars and colors of the bars are based on the Brand Presence factor scores for the respective brand names. The color scheme can be based on user or system configurable thresholds for the Brand Presence factor scores.

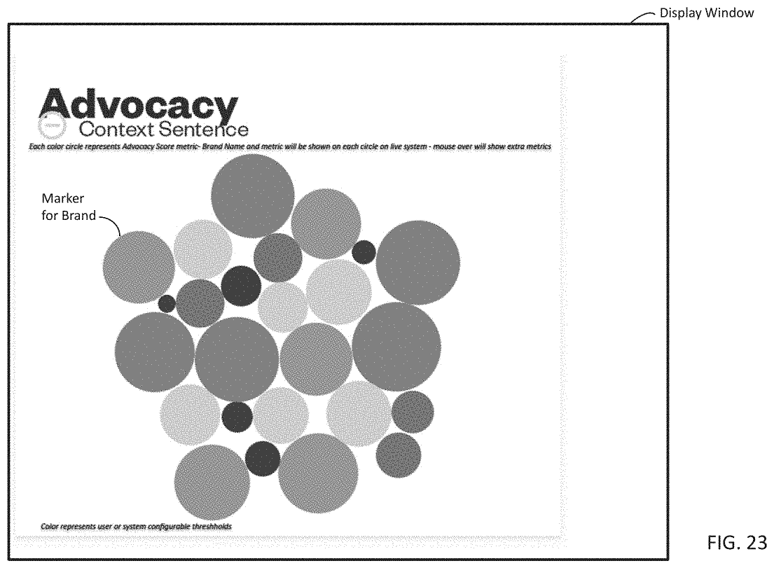

FIG. 23 illustrates an exemplary graphical user interface (e.g., display window) that displays visual markers representing the Brand Advocacy factor scores for different brand names as produced by the process of FIGS. 3A and 3B. The sizes (e.g. radius) and colors of the markers are based on the Brand Advocacy factor scores for the respective brand names. The color scheme can be based on user or system configurable thresholds for the Brand Advocacy factor scores.

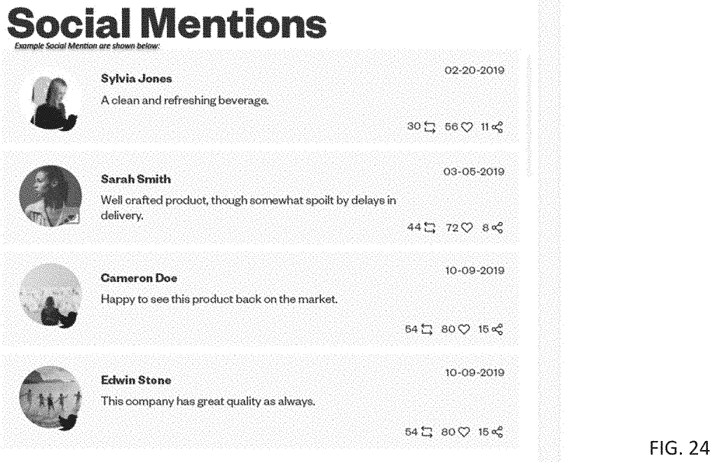

FIG. 24 is a visual depiction of social mentions that are communicated over social media and pertain to a particular brand name for a beverage (not shown). The social mentions can possibly convey negative sentiment toward the particular brand name. The social mentions can also possibly convey positive sentiment toward the particular brand name. Automated data collection methods and data analysis (which typically use machine learning systems) can be used to automatically collect relevant social mention data from one or more social media channels and analyze the data to classify it as invoking positive or negative sentiment for a given brand name (typically specified as a keyword) where appropriate. For example, the social media channels can include Facebook, Twitter, Instagram, Youtube and other social media sources. The classification can be used to derive and store social media metric data related to the given brand name, such as probability of positive social mention for the given brand name within a time period, and/or probability of negative social mention for the given brand name within a time period. Such social media metric data can be obtained and stored in the primary database in association with the corresponding brand name and used to in the brand scoring process as described herein.

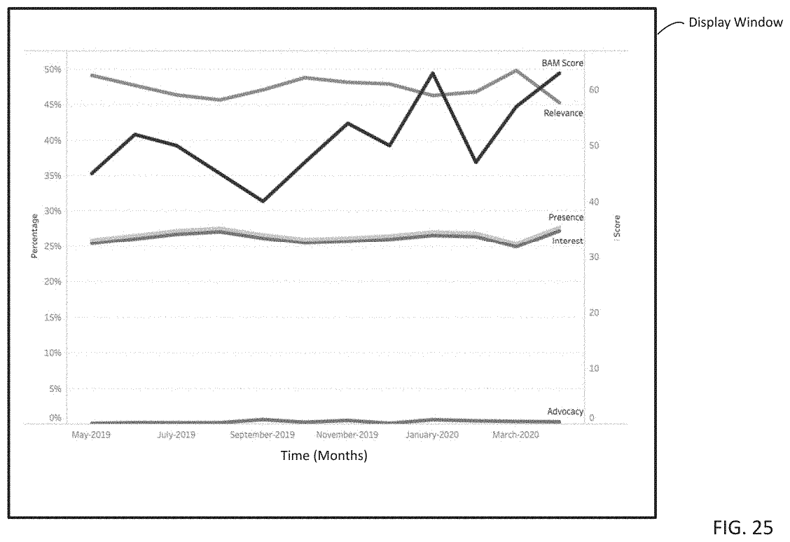

FIG. 25 illustrates an exemplary graphical user interface (e.g., display window) that displays plots of the brand scores (labeled “BAM score”) and related influence factor scores for the Brand Relevance factor (labeled “Relevance”), Brand Presence factor (labeled “Presence”), Brand Interest factor, (labeled “Interest”) and Brand Advocacy factor (labeled “Advocacy”) for a particular brand name for different points in time (e.g., months) within a time window (e.g., May-2019 through April-2020). The brand scores and influence factor scores are produced for a given point in time within the time window by the process of FIGS. 3A and 3B as described herein. The brand scores are computed in the range of 0 to 100 with the relevant range of 0 to 65 provided by the Y-axis on the right-hand-side of the plots. The influence factor scores are computed in the range of 0 to 100 (percent) with the relevant range of 0 to 50 percentage provided by the Y-axis on the left-hand-side of the plots. The X-axis of the plots depicts the months in the time window. The plots can be used to identify how the brand score and related consumer behavior with respect to the particular brand name is changing over the time window. In other embodiments, the time window can cover other periods of time, such as days, quarters, years, or other time periods.

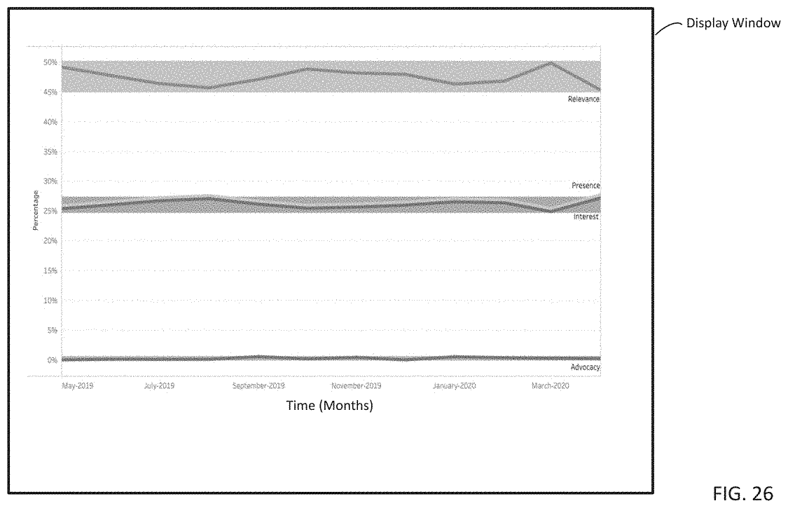

FIG. 26 illustrates an exemplary graphical user interface (e.g., display window) that displays plots of influence factor scores for the Brand Relevance factor (labeled “Relevance”), Brand Presence factor (labeled “Presence”), Brand Interest factor, (labeled “Interest”) and Brand Advocacy factor (labeled “Advocacy”) for a particular brand name for different points in time (e.g., months) within a time window (e.g., May-2019 through April-2020). The influence factor scores are produced for a given point in time within the time window by the process of FIGS. 3A and 3B as described herein. The influence factor scores are computed in the range of 0 to 100 (percent) with the relevant range of 0 to 50 percentage provided by the Y-axis on the left-hand-side of the plots. The X-axis of the plots depicts the months in the time window. The plots can be used to identify how consumer behavior with respect to the particular brand name and related brand category is changing over the time window. In other embodiments, the time window can cover other periods of time, such as days, quarters, years, or other time periods. These plots track how consumer behavior changes across the different media channels over the time window to allow a better understanding of what channels are increasing in importance, and what channels are driving less impact for return on investment with respect to expenditures for the particular brand name.

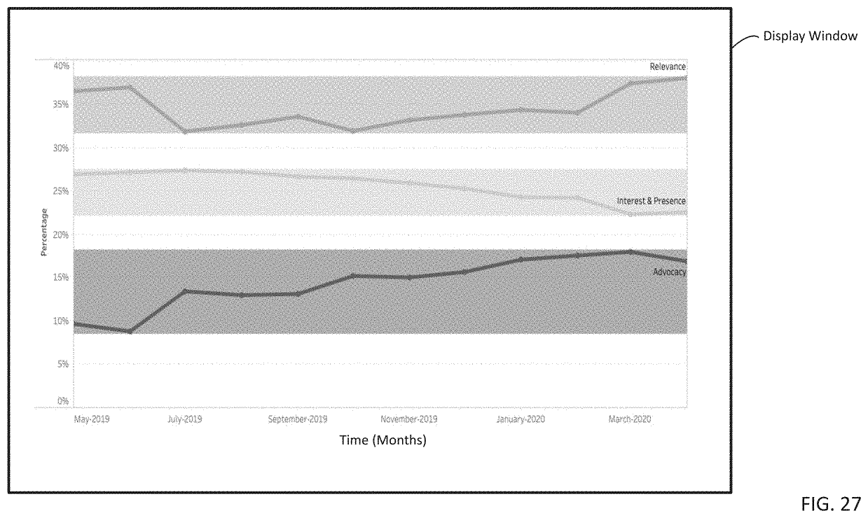

FIG. 27 illustrates an exemplary graphical user interface (e.g., display window) that displays plots of influence factor scores for the Brand Relevance factor (labeled “Relevance”), Brand Presence factor (labeled “Presence”), Brand Interest factor, (labeled “Interest”) and Brand Advocacy factor (labeled “Advocacy”) for a particular brand name for different points in time (e.g., months) within a time window (e.g., May-2019 through April-2020). Similar to FIG. 26, the influence factor scores are produced for a given point in time within the time window by the process of FIGS. 3A and 3B as described herein. The influence factor scores are computed in the range of 0 to 100 (percent) with the relevant range of 0 to 50 percentage provided by the Y-axis on the left-hand-side of the plots. The X-axis of the plots depicts the months in the time window. The plots can be used to identify how consumer behavior with respect to the particular brand name and related brand category is changing over the time window. In other embodiments, the time window can cover other periods of time, such as days, quarters, years, or other time periods.

In alternate embodiments, the influence factor scores over time as related to the Brand Relevance factor and Brand Advocacy factor of FIGS. 26 and 27 can be combined together into a composite score that is plotted over time. In this case, the composite score can be based on a simple month to month, quarter to quarter or year to year difference calculation based on the relevant factors scores for the Brand Relevance factor and Brand Advocacy factor.

Embodiments described in this disclosure can be implemented in digital electronic circuitry, firmware, computer hardware, or in combinations thereof. Furthermore, they may be implemented as one or more computer programs, e.g., one or more modules of program instructions encoded on a non-transitory computer readable medium for execution by, or to control operation of, one or more computer processors.

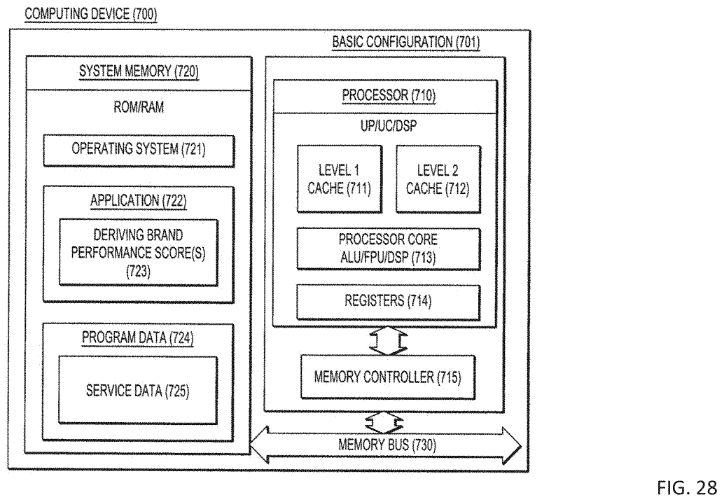

FIG. 28 is a block diagram illustrating an example computing device 700. The computing device 700 can implement any one, or part, or all of the data processing functionality that carries out the processes as described herein. For example, the computing device 700 can implement any one, or part, or all of the data collection server 103, source database 109, data processing system 111, primary database 113, and the portal application server 115 of FIG. 1. The computing device 700 includes one or more processors 710 and system memory 720. A memory bus 730 can be used for communicating between the processor 710 and the system memory 720.

Depending on the desired configuration, processor 710 can be of any type including but not limited to a microprocessor, a microcontroller, a digital signal processor (DSP), a virtual machine, a software appliance, a software-based container, or any combination thereof. Processor 710 can include one or more levels of caching, such as a level one cache 71 1 and a level two cache 712, a processor core 713, and registers 714. The processor core 713 can include an arithmetic logic unit (ALU), a floating-point unit (FPU), a digital signal processing core (DSP Core), or any combination thereof. A memory controller 715 can also be used with the processor 710, or in some implementations the memory controller 715 can be an internal part of the processor 710.

Depending on the desired configuration, the system memory 720 can be of any type including but not limited to volatile memory (such as RAM), non-volatile memory (such as ROM, flash memory, etc.) or any combination thereof. System memory 720 typically includes an operating system 721, one or more applications 722, and program data 724. This described basic configuration is illustrated in FIG. 7 by those components within dashed line 401.

Computing device 700 can have additional features or functionality, and additional interfaces to facilitate communications between the basic configuration 701 and any required devices and interfaces. System memory 720, removable storage 751 and non-removable storage 752 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 400. Any such computer storage media can be part of device 700. The system memory 720 (and possibly other memory) stores program instructions (such as applications 722 and program data 724) that are executed by the processor 710 and implement any one, or part, or all of the data processing functionality that carries out the processes as described herein. In embodiments, the data processing functionality that carries out the processes as described herein can be embodied by modules of program instructions (or program modules) that is stored in the system memory 720 and executed by the processor 710.

For example, in one embodiment, the infrastructure of the system can be embodied by one or more cloud-based computer systems, such as Amazon Web Services (AWS), which has been adapted to the specific design. The database or data warehouse of the system can be embodied by a Relational Database Management System (PostgreSQL) and associated Data Lake (S3), which are configured and designed utilizing the data models in FIGS. 9 and 10. The data analysis and report generating functions can be provided by a Business Intelligence tool, such as Tableau, that interfaces to the Relational Database Management System and associated Data Lake (S3).

Additionally or alternatively, the data analysis and report generation operations implemented by the portal application process can be configured to process the influence-related metric data and/or exposure-related metric data stored in the primary database across dimensions and associated hierarchies. Such processing can involve aggregation or rollup of the influence-related metric data and/or exposure-related metric data across one or more dimensions as well as scoring calculations based on the aggregated data, such as rollup from a specific brand to a collection of brands or brand category and the calculation of brand collection/category scores based on the aggregated data. The scope of the aggregation operations can be determined by the dimensional model of the primary database (e.g., FIG. 10) and the capability of the reporting platform to manage certain types of calculations.

Additionally or alternatively, the data analysis and report generation operations implemented by the portal application process can be configured to implement ‘on-demand’ or ad-hoc querying of original raw data, the influence-related metric data, the exposure-related metric or manipulated scoring data together with processing of such data across a combination of dimensions of the database. Such processing can involve aggregation or rollup of the influence-related metric data and/or exposure-related metric data across one or more dimensions as well as scoring calculations based on the aggregated data. This processing can involve different combinations of dimensions and metrics as expressed in the dimensional data models (e.g., see FIGS. 9 and 10) as well as the calculation of performance scores or measures derived therefrom. The processing to be instantiated via an appropriately configured reporting or ad hoc query processing, such as provided by Tableau. This capability to present data in a flexible manner is implemented either through the standard reporting/dashboards design (e.g., see FIGS. 11 through 24) or through alternative report designs or an ad hoc or on demand query processing. The latter can be configured and developed to work with the dimensional models as specified. The ad hoc or on demand query environment can be triggered by user input and/or based upon user input, such as user input that specifies certain questions or related dimensions pertaining to a brand's performance in a marketplace of competing brands (e.g., particularly in a defined time window and geographical marketplace).

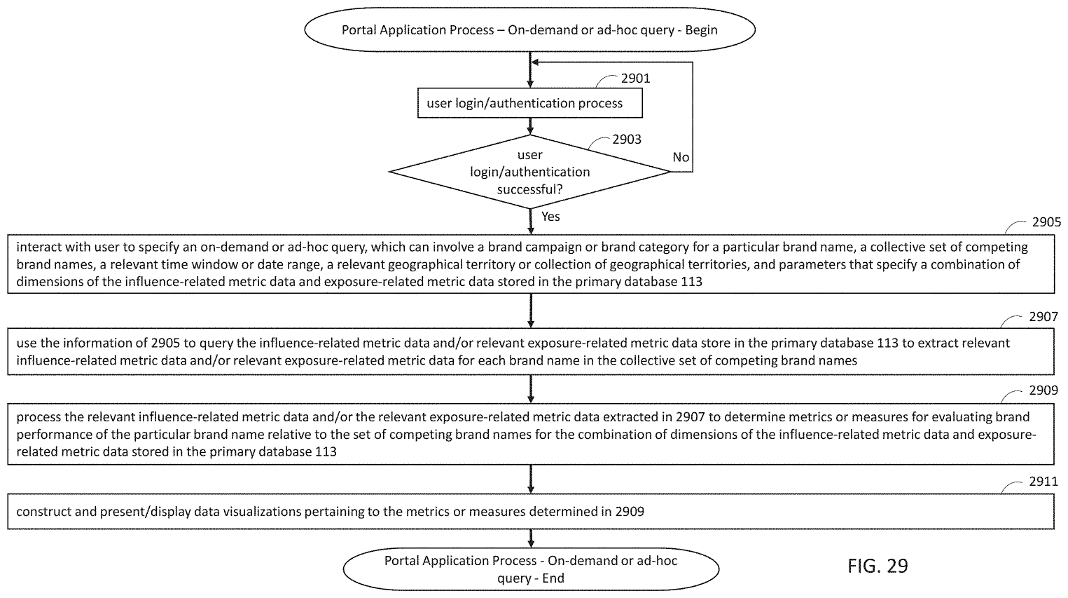

An exemplary embodiment of ad hoc or on demand query processing implemented by the portal application process executing on the portal application server 115 of FIG. 1 is illustrated in the flow chart of FIG. 29. The portal application process begins in block 2901 by invoking a user login/authentication process. The user login/authentication process can require the user to enter a username and password that matches corresponding information stored for the user. Biometric matching data (such as thumbprint or facial image matching) or other suitable methods can also be used as part of the user login/authentication process.

In block 2903, the process checks whether the user login/authentication process of block 2901 was successful. If so, the operations continue to block 2905 to 2911.

In block 2905, the process interacts with the authenticated user to specify an on-demand or ad-hoc query. In embodiments, this query can involve a brand campaign or brand category for a particular brand name, a collective set of competing brand names, a relevant time window or date range, a relevant geographical territory or collection of geographical territories, and parameters that specify a combination of dimensions of the influence-related metric data and exposure-related metric data stored in the primary database 113. For example, the query can relate to one or more of the questions in Table B below, and the combination of dimensions of the query can relate to one more of the performance measures listed in Table C below.

In block 2907, the process uses the information of block 2905 to query the influence-related metric data and/or relevant exposure-related metric data store in the primary database 113 to extract relevant influence-related metric data and/or relevant exposure-related metric data for each brand name in the collective set of competing brand names.

In block 2909, the process uses or processes the relevant influence-related metric data and/or the relevant exposure-related metric data extracted in 2907 to determine metrics or measures for evaluating brand performance of the particular brand name relative to the set of competing brand names for the combination of dimensions of the influence-related metric data and exposure-related metric data stored in the primary database 113. For example, the dimensions of the processed data and the resulting metrics can relate to one more of the performance measures listed in Table C below.

In block 2911, the process constructs and presents for display data visualizations pertaining to the metrics or measures determined in 2909. Examples of such visualizations are described herein with respect to FIGS. 12 to 21.

In embodiments, the on-demand or ad-hoc query processing can provide for flexible and adaptive querying of the data along unique combinations of dimensions and facts to provide insight to key questions, such as
competitive brand intelligence and benchmarking of key performances indicators (KPIs) of brand performance based on a competitive set of brands in a defined time window and geographical marketplace;
tracking of in-market intervention performance and attribution of brand investments in relation to consumer behavior metrics and share of market variance; and
dynamic statistical modeling and gap analysis of expected versus actual performance based on brand influence index and attraction index and their component KPIs.

The underpinning to allow this type of overarching flexibility across all metrics and dimensions stems from the design of the dimensional model of the database considering the following:

i) the key questions and subject areas at a high level associated with brand performance and specifically the subject areas, Sales, Brand and Marketing as specified in Table B below.

| Key Question | Subject Area |
|---|---|
| Market share (% Volume by Channel) | Sales |
| What is the health of my brand? And how do I improve it? | Brand |
| How do I improve brand sentiment? | Brand |
| How do I improve brand interest? | Brand |
| How do I improve brand relevance | Brand |
| How do I improve brand engagement? | Brand |
| How do I improve brand advocacy? | Brand |
| Is my brand relevant in the marketplace? | Brand |
| Who are the people we are designing our business to attract | Brand |
| What do people think about my brand? | Brand |
| What are my Brand's strengths and opportunities? | Brand |
| Are we leveraging our brands assets effectively? | Brand |
| What is the feasibility, and business effort to fill the gap in | Brand |
| a brands positioning against the ideal/competitive set? | |
| What is the size of the market opportunity? | Marketing |
| How do we compare to our competitors on key drivers (of | Marketing |
| purchase)? | |

ii) fundamental performance metrics associated with brands as specified in Table C below.

TABLE C
Fundamental Brand Performance Measures
.
EXPOSURE metric—Total value of mass and digital media expenditures
spent to amplify brand.
PAID INFLUENCE metric—Measures how much a brand is being
amplified through expenditures, adjusted by APPEAL metric
APPEAL metric—Measure of positive and negative sentiment towards a
brand to determine consumers are responding to messaging
EFFECTIVENESS Factor—based on a share of total market parameter or
metric that reflects current effort of the brand owner or agent in
increasing share of the particular brand name in the total market of the
brand category and another share of total market parameter or metric that
reflects actual changes or variation of the share of the particular brand
name in the total market of the brand category over time; the
EFFECTIVENESS factor can be used to adjust the EXPOSURE metric
for the brand names for the corresponding time period
INTEREST score or metric—Measures how well a brand is likely to
perform in unpaid search.
PRESENCE score or metric—Measures how difficult it is to rank for a
brand’s keywords in search.
RELEVANCE score or metric—Measures how much website traffic a
brand gets, relative to competitors.
ADVOCACY score or metric—Measures the quantity and net sentiment
(positive or negative attitudes towards a brand) of online brand mentions.
EARNED ATTRACTION score or metric—Measure of the performance
of a brand across key channels, including Interest, Presence, Relevance,
and Advocacy, by combining the associated influence-related metrics
BRAND (OR BAM) score or metric—based on a combination of
influence-related metrics (e.g., EARNED ATTRACTION score) and
exposure-related metrics (e.g., EXPOSURE metric, PAID INFLUENCE
metric, APPEAL metric, and EFFECTIVENESS FACTOR)

iii) date, geolocation, and other dimensional and reference data needed to describe and frame key questions as specified in Table D below. These dimensions bound the metrics that inform the questions.

TABLE D
Descriptive/Analytical Dimensions

| Logical Dimension | |
|---|---|
| Name | Notes |
| Date Dimension | Date Dimension at the grain of a single day and |
| | specifies common date attributes. |
| Geography | Geography dimension in the current model this is |
| Dimension | that the grain of a country due to availability of |
| (Country grain) | data. In principle geographic data could be as low |
| | as postcode level. |
| Brand Dimension | Brand related attributes |
| Product Dimension | Product related attributes |
| Attraction Channel | Attraction channel for example ‘Web’ |
| Dimension | |
| Client Dimension | Attributes associated with the Client or owner of |
| | a Brand |
| Intervention | Event-based interventions such as a marketing |
| | campaign |
| Competitive set | Specifies collections of Brands associated with a |
| | competitive set for a particular Client |
| Mentions Lookup | Additional Intervention meta data associated with |
| | social Mentions |
| Ads Lookup | Additional Intervention meta data associated with |
| | Ads |
| Control Table | Manages Client peers and parameters |

iv) identification and setting of the grain of the fact table of the database to allow key questions and associated performance metrics to be resolved for different combinations of dimensions and facts. This grain can be specified by the primary key of the fact table which in turn is composed of all foreign key relations from the associated dimension tables.

Thus, particular embodiments of the subject matter have been described. Other embodiments are within the scope of the following claims. In some cases, the actions recited in the claims can be performed in a different order and still achieve desirable results. In addition, loops or portions thereof can be replaced with corresponding instructions or threads that perform the operations of the loops in sequence or possibly in parallel with one another. In addition, the processes depicted in the accompanying figures do not necessarily require the particular order shown, or sequential order, to achieve desirable results. In certain implementations, multitasking and parallel processing may be advantageous. It will therefore be appreciated by those skilled in the art that yet other modifications could be made to the provided invention without deviating from its spirit and scope as claimed.

What is claimed is:

1. A computer-implemented method of evaluating brand performance employing at least one data processor having processor-implemented instructions, the method comprising:
a) providing or determining a set of input parameters, wherein the set of input parameters specify a plurality of brand names;
b) performing first data processing operations for each given brand name in the plurality of brand names to collect influence-related source data and expenditure-related source data from a plurality of different data sources, generate influence-related metric data and expenditure-related metric data corresponding to the influence-related source data and expenditure-related source data, and store the influence-related metric data and the expenditure-related metric data in a data store in association with the given brand name and data representing a time period and geographical territory related thereto;
c) interacting with a user to identify a particular brand name or brand campaign and a relevant geographical territory and a relevant time window, wherein a set of competing brand names is associated with the particular brand name or brand campaign; and
d) performing second data processing operations for each particular brand name in the set of competing brand names in response to the user interaction of c), wherein the second data processing operations determine a brand score for the particular brand name from the influence-related metric data and the expenditure-related metric data that is stored in the data store and corresponds to the particular brand name and the relevant geographical territory and the relevant time window;
wherein the second data processing operations of d) calculate the brand score for the particular brand name by adjusting monetary expenditures associated with the particular brand name for the relevant geographical territory and the relevant time window as determined from the expenditure-related metric data for the particular brand name stored in the data store, wherein the adjusting is based on an effectiveness factor for the particular brand name determined for market share of the particular brand name over time.

2. A method according to claim 1, wherein:
the market share of the particular brand name is a measure of consumer preference for one or more products that are branded by the particular brand name over other similar or competing products.

3. A method according to claim 1, wherein:
the effectiveness factor for the particular brand name is configured to adjust monetary expenditures for the particular brand name in a manner that rewards monetary expenditures that contribute to the market share gain of the particular brand name over time and penalizes monetary expenditures that contribute to market share loss of the particular brand name over time.

4. A method according to claim 1, wherein:
the effectiveness factor for the particular brand name is based on first and second parameters, wherein the first parameter reflects effort to increase market share of the particular brand name in the total market of the brand category, and the second parameter reflects changes of the market share of the particular brand name in the total market of the brand category over time.

5. A method according to claim 4, wherein:
the effectiveness factor for the particular brand name is based on a ratio of the first and second parameters.

6. A method according to claim 4, wherein:
the first parameter is computed as a ratio TME/MS, where TME is the total media expenditures for the particular brand name in the relevant time window and the relevant geographical territory, and MS is market share of the particular brand name in its associated brand category for the relevant time window and the relevant geographical territory; and
the second parameter is computed as a ratio TME′/MS′, where TME′ is the total media expenditures for the particular brand name in a defined time period corresponding to the relevant time window and in the relevant geographical territory, and MS' is the market share of the particular brand name in its associated brand category for the defined time period corresponding to the relevant time window and for the relevant geographical territory.

7. A method according to claim 6, wherein:
the effectiveness factor for the particular brand name is based on a ratio of the first and second parameters normalized by a ratio of third and fourth parameters;
wherein the third parameter is computed as a maximum ratio or some other statistically significant mean of the ratio TME/MS for all brand names in the brand category for the relevant time window and the relevant geographical territory; and
wherein the fourth parameter is computed as a maximum ratio or some other statistically significant mean of the ratio TME′/MS' for all brand names in the brand category in a certain time period corresponding to the relevant time window and in the relevant geographical territory.

8. A method according to claim 1, wherein:
the brand score for the particular brand name is calculated from i) an influence score for the particular brand name and the relevant geographical territory and the relevant time window and ii) an exposure score for the particular brand name and the relevant geographical territory and the relevant time window, wherein the exposure score for the particular brand name and the relevant geographical territory and the relevant time window is based on the effectiveness factor for the particular brand name.

9. A method according to claim 8, wherein the influence score for the particular brand name and the relevant geographical territory and the relevant time window is calculated by:
d)i) querying the data store to retrieve influence-related metric data corresponding to the particular brand name and a plurality of predetermined influence factors and the relevant geographical territory and at least one time period that covers the relevant time window, and using the retrieved influence-related metric data to calculate influence factor scores that correspond to the particular brand name and the relevant geographical territory and the relevant time window, and
d)ii) calculating the influence score for the particular brand name and the relevant geographical territory and the relevant time window based on the influence factor scores of d)i) and a set of corresponding weights that specify relative weight of the influence factor scores in contribution to the influence score.

10. A method according to claim 9, wherein:
the plurality of predetermined influence factors relates to brand influence across different media channels.

11. A method according to claim 9, wherein:
the set of weights of d)ii) corresponds to the plurality of predetermined influence factors, and the set of weight of d)ii) is based on a brand category for the particular brand name.

12. A method according to claim 8, wherein the exposure score for the particular brand name and the relevant geographical territory and the relevant time window is calculated by:
d)iii) querying the data store to retrieve expenditure-related metric data corresponding to the particular brand name and the relevant geographical territory and at least one time period that covers the relevant time window, and using the retrieved expenditure-related metric data and the effectiveness factor for the particular brand name and the relevant geographical territory and the relevant time window to calculate the exposure score for the particular brand name and the relevant geographical territory and the relevant time window.

13. A method according to claim 1, further comprising:
presenting for display a visual representation of the brand scores as calculated in d) for the set of competing brand names, wherein the visual representation includes a plurality of visual elements corresponding to the set of competing brand names plotted in a two-dimensional exposure-influence coordinate system.

14. A method according to claim 13, wherein:
the two-dimensional exposure-influence coordinate system comprises four quadrants including a first quadrant corresponding to low exposure and low attraction, a second quadrant corresponding to low exposure and high attraction, a third quadrant corresponding to high exposure and low attraction, and a fourth quadrant corresponding to high exposure and high attraction.

15. A method according to claim 1, wherein the first data processing operations of b) comprise:
b)i) automatically accessing a plurality of data sources corresponding to a plurality of predetermined influence factors through data communication over the Internet and obtaining and storing influence-related source data for the plurality of predetermined influence factors that pertains to the given brand name for a time period and a geographical territory; and
b)ii) automatically accessing at least one additional data source through data communication over the Internet and obtaining and storing expenditure-related source data pertaining to the given brand name for a time period and a geographical territory.

16. A method according to claim 1, wherein:
the first data processing operations of b) are performed in response to detection of at least one trigger event or condition, wherein the at least one trigger event or condition involves user interaction or a time-based scheduled event.

17. A method according to claim 1, wherein:
the first data processing operations of b) are performed over different time periods and different geographical territories, wherein the plurality of different data sources accessed in b) vary over the different geographical territories.

18. A method according to claim 1, wherein:
the expenditure-related source data pertaining to the given brand name for a time period and a geographical territory reflects monetary expenditures associated with the given brand name over the time period and the geographical territory across different media channels; and
the plurality of different data sources accessed in b) comprises a plurality of data sources corresponding to the different media channels.

19. A method according to claim 18, wherein:
the different media channels include mass market media channels and digital media channels and social media channels.

20. A method according to claim 1, further comprising:
determining at least one social media metric for each brand name in the set of competing brand names, wherein the brand score for the particular brand name is further based on the at least one social media metric for the particular brand name.

21. A method according to claim 19, wherein:
the at least one social media metric is selected from the group including number of mentions in a time period, percentage of positive sentiment in a time period, and percentage of negative sentiment in a time period.

22. A method according to claim 1, wherein:
the brand score for the particular brand name and the relevant geographical territory and the relevant time window as calculated in d) has a range from −1 to +1 or 0 to 100.

23. A method according to claim 1, further comprising:
ranking the plurality of brand names based on the brand scores as calculated in d) for the set of competing brand names.

24. A method according to claim 23, wherein:
the ranking of the set of competing brand names involves converting the brand scores as calculated in d) into ranking scores in a range of 0 to 100.

25. A method according to claim 1, further comprising:
presenting for display brand scores for the particular brand name for different points in time within a time window.

26. A method according to claim 1, further comprising:
presenting for display influence factor scores for the particular brand name for different points in time within a time window.

27. A data processing system comprising at least one processor and at least one storage device storing instructions that are executable on the at least one processor to cause the at least one processor to perform the method of claim 1.
